(19) United States
(12) Patent Application Publication
(10) Pub. No.: US 2026/0044369 A1
(43) Pub. Date: Feb. 12, 2026

(54) SEARCHING PARALLEL SCHEDULES FOR EXECUTION OF ARTIFICIAL INTELLIGENCE WORKLOADS

(71) Applicant: Microsoft Technology Licensing, LLC, Redmond, WA (US)

(72) Inventors: Fanny NINA PARAVECINO, San Jose, CA (US); Timothy Lawrence HARRIS, Cambridge (GB); Alexander WETMORE, Redmond, WA (US); Woosuk KWON, Berkeley, CA (US)

(73) Assignee: Microsoft Technology Licensing, LLC, Redmond, WA (US)

(21) Appl. No.: 18/907,161

(22) Filed: Oct. 4, 2024

Related U.S. Application Data
(60) Provisional application No. 63/680,785, filed on Aug. 8, 2024.

(51) Int. Cl. G06F 9/48

(52) U.S. Cl. CPC G06F 9/4881

(57) ABSTRACT

A computer-implemented method can receive an internal representation of a transformer model which defines one or more repeating blocks, each block including a sequence of cells, and each cell including a set of tasks of the transformer model. The method can search for a plurality of parallel schedules for partitioning devices included in a device cluster for parallel execution of the transformer model. The searching includes determining a number of model replicas, determining a number of stages that divide the one or more repeating blocks, determining a number of cell replicas for each cell in a block, and for each cell replica of a cell, generating a task mapping which maps the set of tasks included in the cell to devices partitioned into the cell replica.

### CROSS-REFERENCE TO RELATED APPLICATIONS

This application claims the benefit of U.S. Provisional Ser. No. 63/680,785, filed Aug. 8, 2024, which is incorporated herein by reference in its entirety.

### BACKGROUND

The rapidly evolving field of generative artificial intelligence (AI), encompassing large language models (LLMs), is ushering in a myriad of new challenges. A prominent challenge is the escalating size of these generative AI models, which demands distributed execution to manage the substantial computational power required. However, developing an effective parallelism for partitioning devices is a complex task. It involves strategically distributing the computational workload across various units, both within and across devices, while maintaining synchronization and managing intricate interdependencies within the generative AI models. This complexity is further amplified by the dynamic nature of computational resources and the need for real-time adaptability. Therefore, a more systematic and adaptive approach to parallelism is desirable to effectively manage these challenges and fully harness the potential of generative AI models.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In some aspects, the techniques described herein relate to a computer-implemented method including receiving an internal representation of a transformer model, an internal representation of a device cluster, and an internal representation of a workload for execution of the transformer model on the device cluster, and generating a plurality of candidate execution plans based on the internal representation of the transformer model and the internal representation of the device cluster. Each candidate execution plan represents a unique parallel schedule for partitioning devices in the device cluster for parallel execution of the transformer model. The method further includes determining an optimal execution plan, including: evaluating resource usage of the plurality of candidate execution plans based on the internal representation of the workload, and selecting, among the plurality of candidate execution plans, the optimal execution plan which yields the lowest resource usage. The act of evaluating resource usage includes simulating execution of the transformer model on the device cluster to process the workload.

In some aspects, the techniques described herein relate to a computing system including: memory; a processor system coupled to the memory; and one or more computer readable storage media storing instructions that, when loaded into the memory, cause the processor system to perform operations including receiving an internal representation of a transformer model, an internal representation of a device cluster, and an internal representation of a workload for execution of the transformer model on the device cluster, and generating a plurality of candidate execution plans based on the internal representation of the transformer model and the internal representation of the device cluster. Each candidate execution plan represents a unique parallel schedule for partitioning devices in the device cluster for parallel execution of the transformer model. The operations further include determining an optimal execution plan, including: evaluating resource usage of the plurality of candidate execution plans based on the internal representation of the workload, and selecting, among the plurality of candidate execution plans, the optimal execution plan which yields the lowest resource usage. The act of evaluating resource usage includes simulating execution of the transformer model on the device cluster to process the workload.

In some aspects, the techniques described herein relate to one or more computer-readable media having encoded thereon computer-executable instructions causing one or more processors to perform a method, the method including receiving an internal representation of a transformer model, an internal representation of a device cluster, and an internal representation of a workload for execution of the transformer model on the device cluster, and generating a plurality of candidate execution plans based on the internal representation of the transformer model and the internal representation of the device cluster. Each candidate execution plan represents a unique parallel schedule for partitioning devices in the device cluster for parallel execution of the transformer model. The method further includes determining an optimal execution plan, including: evaluating resource usage of the plurality of candidate execution plans based on the internal representation of the workload, and selecting, among the plurality of candidate execution plans, the optimal execution plan which yields the lowest resource usage. The act of evaluating resource usage includes simulating execution of the transformer model on the device cluster to process the workload.

In some aspects, the techniques described herein relate to a computer-implemented method including generating a parallel schedule for partitioning devices included in a device cluster for parallel execution of a transformer model, and for a given workload, executing the transformer model on the device cluster according to the parallel schedule. The transformer model is represented by a chain of cells, each cell including a set of tasks of the transformer model. Generating the parallel schedule includes dividing the chain of cells into one or more sequential stages, creating one or more replicas of the transformer model or some of the cells, and mapping the set of tasks included in a cell to one or more devices of the device cluster.

In some aspects, the techniques described herein relate to a computing system including: memory; a processor system coupled to the memory; and one or more computer readable storage media storing instructions that, when loaded into the memory, cause the processor system to perform operations including generating a parallel schedule for partitioning devices included in a device cluster for parallel execution of a transformer model, and for a given workload, executing the transformer model on the device cluster according to the parallel schedule. The transformer model is represented by a chain of cells, each cell including a set of tasks of the transformer model. Generating the parallel schedule includes dividing the chain of cells into one or more sequential stages, creating one or more replicas of the transformer model or some of the cells, and mapping the set of tasks included in a cell to one or more devices of the device cluster.

In some aspects, the techniques described herein relate to one or more computer-readable media having encoded thereon computer-executable instructions causing one or more processors to perform a method, the method including generating a parallel schedule for partitioning devices included in a device cluster for parallel execution of a transformer model, and for a given workload, executing the transformer model on the device cluster according to the parallel schedule. The transformer model is represented by a chain of cells, each cell including a set of tasks of the transformer model. Generating the parallel schedule includes dividing the chain of cells into one or more sequential stages, creating one or more replicas of the transformer model or some of the cells, and mapping the set of tasks included in a cell to one or more devices of the device cluster.

In some aspects, the techniques described herein relate to a computer-implemented method including receiving an internal representation of a transformer model, and searching for a plurality of parallel schedules for partitioning devices included in a device cluster for parallel execution of the transformer model. The internal representation defines one or more repeating blocks. Each block includes a sequence of cells, and each cell includes a set of tasks of the transformer model. The searching includes determining a number of model replicas. Each model replica represents a copy of the transformer model. Devices included in the device cluster are partitioned into the number of model replicas. The searching also includes determining a number of stages that divide the one or more repeating blocks. Devices partitioned into each model replica are partitioned into the number of stages. The searching further includes determining a number of cell replicas for each cell in a block. Each cell replica represents a copy of the corresponding cell. Devices partitioned into each stage are partitioned into the number of cell replicas. For each cell replica of a cell, the searching additionally includes generating a task mapping which maps the set of tasks included in the cell to devices partitioned into the cell replica.

In some aspects, the techniques described herein relate to a computing system including: memory; a processor system coupled to the memory; and one or more computer readable storage media storing instructions that, when loaded into the memory, cause the processor system to perform operations including receiving an internal representation of a transformer model, and searching for a plurality of parallel schedules for partitioning devices included in a device cluster for parallel execution of the transformer model. The internal representation defines one or more repeating blocks. Each block includes a sequence of cells, and each cell includes a set of tasks of the transformer model. The searching includes determining a number of model replicas. Each model replica represents a copy of the transformer model. Devices included in the device cluster are partitioned into the number of model replicas. The searching also includes determining a number of stages that divide the one or more repeating blocks. Devices partitioned into each model replica are partitioned into the number of stages. The searching further includes determining a number of cell replicas for each cell in a block. Each cell replica represents a copy of the corresponding cell. Devices partitioned into each stage are partitioned into the number of cell replicas. For each cell replica of a cell, the searching additionally includes generating a task mapping which maps the set of tasks included in the cell to devices partitioned into the cell replica.

In some aspects, the techniques described herein relate to one or more computer-readable media having encoded thereon computer-executable instructions causing one or more processors to perform a method, the method including receiving an internal representation of a transformer model, and searching for a plurality of parallel schedules for partitioning devices included in a device cluster for parallel execution of the transformer model. The internal representation defines one or more repeating blocks. Each block includes a sequence of cells, and each cell includes a set of tasks of the transformer model. The searching includes determining a number of model replicas. Each model replica represents a copy of the transformer model. Devices included in the device cluster are partitioned into the number of model replicas. The searching also includes determining a number of stages that divide the one or more repeating blocks. Devices partitioned into each model replica are partitioned into the number of stages. The searching further includes determining a number of cell replicas for each cell in a block. Each cell replica represents a copy of the corresponding cell. Devices partitioned into each stage are partitioned into the number of cell replicas. For each cell replica of a cell, the searching additionally includes generating a task mapping which maps the set of tasks included in the cell to devices partitioned into the cell replica.

The foregoing and other features and advantages of the disclosed technology will become more apparent from the following detailed description, which proceeds with reference to the accompanying figures.

### BRIEF DESCRIPTION OF THE DRAWINGS

FIG. 1 is an overall block diagram of an example computing system implementing a framework for automatic parallel execution of AI workloads.

FIG. 2 is a flowchart illustrating an example overall method for automatic determination of a parallel schedule for execution of AI workloads.

FIG. 3 is a flowchart illustrating an example overall method for using a parallel schedule including mixed parallelisms for execution of AI workloads.

FIG. 4 is a flowchart illustrating an example overall method for searching parallel schedules for execution of AI workloads.

FIG. 5A is a block diagram illustrating a device cluster.

FIG. 5B is a block diagram illustrating an internal representation of the device cluster of FIG. 5A.

FIG. 6 is a block diagram illustrating a cell of a transformer model.

FIG. 7A is a block diagram illustrating a multi-head attention cell of a transformer model.

FIG. 7B is a block diagram illustrating a multi-layer perception cell of a transformer model.

FIG. 8 is a block diagram illustrating a parallel multi-head attention and multi-layer perception cell of a transformer model.

FIG. 9A is a block diagram illustrating a mixture of experts cell of a transformer model.

FIG. 9B is a block diagram illustrating a transformed structure of the mixture of experts cell of FIG. 9A.

FIG. 10A is a block diagram illustrating a structure of a transformer model including a block containing two different cells.

FIG. 10B is a portion of a pseudo-code defining a class for internal representation of a transformer model.

FIG. 11 shows block diagrams illustrating structures of three different transformer models.

FIG. 12A is a block diagram illustrating pipeline parallelism.

FIG. 12B is a block diagram illustrating data parallelism.

FIG. 13 shows examples representing different parallel schedules.

FIG. 14A is a portion of a pseudo-code of a class defining a parallel schedule.

FIG. 14B is a portion of a pseudo-code of a class defining task mapping.

FIG. 14C is a portion of a pseudo-code of a class defining a parallel template.

FIG. 15A is a block diagram illustrating an example parallel template for a multi-head attention cell.

FIG. 15B is a block diagram illustrating an example parallel template for a multi-layer perception cell.

FIG. 15C is a block diagram illustrating an example parallel template for a parallel multi-head attention and multi-layer perception cell.

FIG. 16A is a block diagram illustrating an example parallel template for a mixture of experts cell.

FIG. 16B is a block diagram illustrating another example parallel template for a mixture of experts cell.

FIG. 17A is a block diagram illustrating an example parallel schedule including a mixture of experts cell positioned between two multi-head attention cells.

FIG. 17B is a block diagram illustrating adding resharding operations to the parallel schedule of FIG. 17A.

FIG. 17C is a block diagram illustrating optimization of the resharding operations of FIG. 17B.

FIG. 18A is a block diagram illustrating a structure of an example mixture of experts cell which has two experts.

FIG. 18B is a block diagram illustrating a structure of another example mixture of experts cell which has two experts.

FIG. 19 is a portion of a pseudo-code of a method for searching candidate execution plans for parallel execution of a transformer model.

FIG. 20 depicts example results of one simulation study.

FIG. 21 depicts example experimental results of search space size and search time for a transformer model.

FIG. 22 depicts example experimental results of search space size and search time for another transformer model.

FIG. 23 is a block diagram of an example computing system in which described embodiments can be implemented.

FIG. 24 is a block diagram of an example cloud computing environment that can be used in conjunction with the technologies described herein.

### DETAILED DESCRIPTION

### Overview of Parallelisms in Generative AI

The field of generative AI is rapidly evolving, with state-of-the-art generative AI being powered by transformer models. These models, a type of neural network architecture, have the ability to transform an input sequence into an output sequence by learning the context and tracking relationships between components of the sequence. However, as these transformer models grow in size and complexity, they present a significant challenge stemming the need for distributed execution to manage the substantial computational power required.

To overcome this challenge, parallelism can be employed for partitioning computing resources into smaller, more manageable sub-tasks that can be processed simultaneously.

Developing an effective parallelism is a complex but crucial task that involves strategically distributing the computational workload across various units, both within and across devices. This distribution not only allows for the management of the computational demands of large transformer models but also maintains synchronization and manages intricate interdependencies within the generative AI models.

Previous works on parallelism have attempted to formulate automatic model partitioning as a constrained optimization problem, which can be solved using methods such as integer linear programming (ILP) and dynamic programming (DP). ILP is a method to find the best outcome in a mathematical model whose requirements are represented by linear relationships, while DP is a method for solving complex problems by breaking them down into simpler steps.

However, these previous works have several limitations. Some methods, such as Alpa, are not scalable. As the model size gets larger, the number of decision variables in the ILP formulation increases exponentially, leading to a significant increase in the search time for very large models. Other methods, like Piper, limit the search space in exchange for reducing the search time. While this potentially may resolve the scalability problem, it can lead to suboptimal performance.

Furthermore, all previous methods rely on static input/output shapes in formulating the optimization problem. This is challenging for transformer models because the input and output sequence lengths are not statically determined a priori. The input length can be determined by the user's prompt, which can be a single word, a sentence, or multiple sentences. The input length can vary depending on the complexity of the user's request or the context of the conversation. The output length can be determined by the nature of the response generated. For instance, a simple question may require a short answer, while a complex query or a request for a detailed explanation may result in a longer response. The dynamic batching mechanism (a technique that allows for variable input/output shapes to enhance computation efficiency) like Orca, makes the input/output shape expression even more complex.

The impact of varying input/output size on the performance or throughput of the transformer model is significant. For instance, long input sequences tend to be compute-bound due to their extensive processing requirements, while long outputs tend to be memory-bound as they require more storage space during computation. Dynamic batching can lead to larger memory for activation, enabling larger batch sizes and resulting in higher throughput.

Moreover, for mixture of experts (MoE) models (a type of model where different parts or ‘experts’ specialize in different data patterns), the number of tokens routed to each expert is dynamically determined, adding another layer of complexity.

The technologies described herein address many of the technical challenges previously mentioned. Specifically, disclosed herein is an automatic partition framework that contains new abstractions. This framework leverages the repeated layer structure in a transformer model, ensuring that the search time does not increase exponentially with the number of layers, without constraining the search space. The disclosed automatic partition framework also accommodates the dynamic nature of generative AI inference in identifying an optimal partitioning scheme and implementing it. This systematic and adaptive approach to parallelism effectively navigates the challenges previously described and fully taps into the potential of generative AI models.

### Example Framework

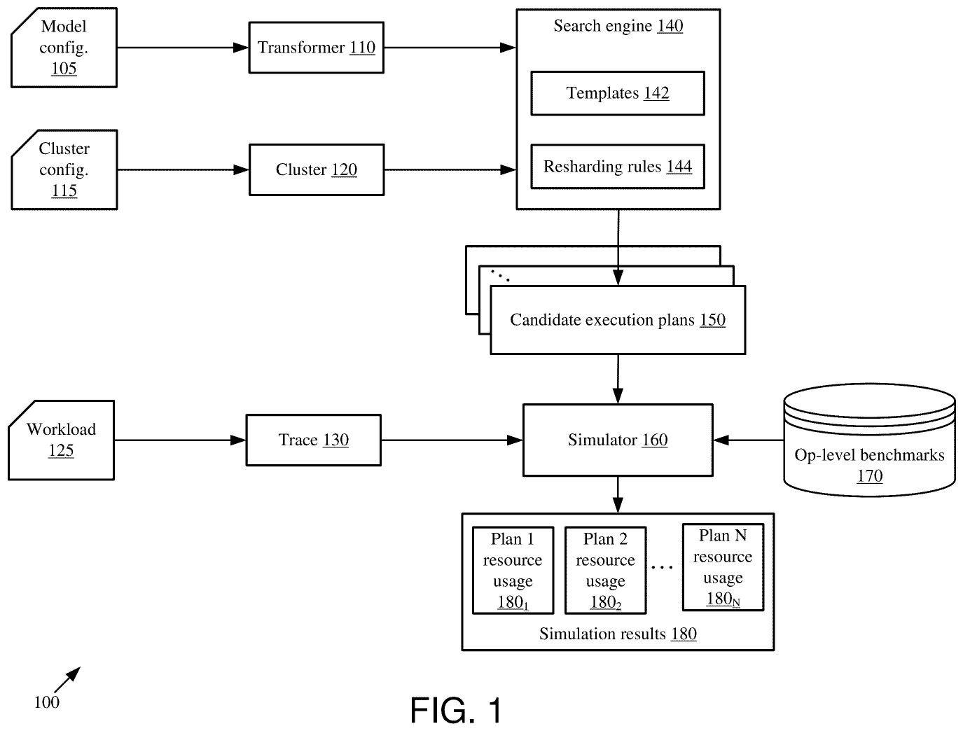

FIG. 1 shows an overall block diagram of an example computing system 100 implementing the automatic partition framework disclosed herein.

The computing system 100 receives three inputs: configurations of a transformer model 105, configurations for a device cluster 115, and specifications for a workload 125. These inputs can be transformed into corresponding internal representations (IRs), which are software artifacts (e.g., classes) abstracting structures and/or characteristics of these input. Specifically, the three inputs can be respectively transformed into an IR of the transformer model 110 (denoted as a “Transformer” class) which defines structural components of the transformer model, an IR of the device cluster 120 (denoted as a “Cluster” class) which defines a logical structure of the device cluster, and an IR of the workload 130 (denoted as a “Trace” class) which specifies how many user requests (e.g., the number of prompts) need to be processed, and the input size (e.g., the prompt length or the number of tokens in the prompt) and output size (e.g., the output length or the number of tokens generated in the output) of each user request.

A search engine 140 is configured to generate a plurality of candidate execution plans 150 based on the IR of the transformer model 110 and the IR of the device cluster 120. As described herein, each candidate execution plan 150 represents a unique parallel schedule for partitioning devices in the device cluster for parallel execution of the transformer model. As described more fully below, a parallel schedule can be devised by leveraging various forms of parallelisms such as pipeline parallelism, data parallelism, and task parallelism, and their combinations to enhance performance of parallel execution.

Each candidate execution plan 150 can also define types of collective communication that coordinate or synchronize the output of individual tasks. The types of collective communication define how data aggregation, data distribution, and synchronization are performed in distributed computing systems. Example types of collective communications include all-reduce (a process where all nodes in a distributed system share their data and reduce it to a single result, e.g., using sum), all-gather (a process where every node gathers data from all other nodes, resulting in all nodes having the complete data set), reduce-scatter (a process where all nodes send their data to be reduced into a single result, which is then scattered back to all nodes), all-to-all (a process where each node sends its own data to all other nodes in the system), etc.

During the process of generating of candidate execution plans 150, the search engine 140 can utilize registered parallel templates 142 for tensor parallelism and expert parallelism, and combining them with data and pipeline parallelisms, as described more fully below.

When combining different parallelisms, resharding rules 144 can be applied to select the appropriate type of collective communications between layers or cells of the transformer model. As described herein, the tensor parallelism and expert parallelism, collectively, can also be referred to as “task parallelism.”

These candidate execution plans 150 are then evaluated by a simulator 160 for their performance. The simulator 160 can be a software module configured to simulate a dynamic batching algorithm and use operation-level (or simply “op-level”) benchmarks 170 to estimate the total or end-to-end processing time for each candidate execution plan to process all input requests specified in the IR of the workload 130. The total processing time includes operation time spent in performing specific tasks and operation time spent by collective communications, the latter of which can be deemed as an overhead. The simulations for these candidate execution plans 150 can be parallelized across multiple CPUs.

The simulator 160 can generate simulation results 180, which can include estimated resource usage and runtime statistics of each candidate execution plan 150. For example, for N candidate execution plans 150, the simulation results 180 can be represented as Plan 1 resource usage 180₁ through Plan N resource usage 180_{N}. In some examples, the resource usage for a candidate execution plan 150 includes an estimated total processing time for using candidate execution plan to process all input requests in the workload. In some examples, the simulator 160 can further be configured to determine an optimal execution plan which yields the lowest resource usage among the plurality of candidate execution plans 150. The determined optimal execution plan can be recommended by the computing system 100 for parallel processing of the workload 125.

In practice, the systems shown herein, such as the computing system 100, can vary in complexity, with additional functionality, more complex components, and the like. For example, there can be additional functionality within the search engine 140. Additional components can be included to implement security, redundancy, load balancing, report design, data logging, and the like.

The described computing systems can be networked via wired or wireless network connections, including the Internet. Alternatively, systems can be connected through an intranet connection (e.g., in a corporate environment, government environment, or the like).

The computing system 100 and any of the other systems described herein can be implemented in conjunction with any of the hardware components described herein, such as the computing systems described below (e.g., processing units, memory, and the like). In any of the examples herein, parallel schedules, transformer models, cells, blocks, replicas, tasks, and the like can be stored in one or more computer-readable storage media or computer-readable storage devices. The technologies described herein can be generic to the specifics of operating systems or hardware and can be applied in any variety of environments to take advantage of the described features.

### Example Overall Method for Automatic Determination of a Parallel Schedule

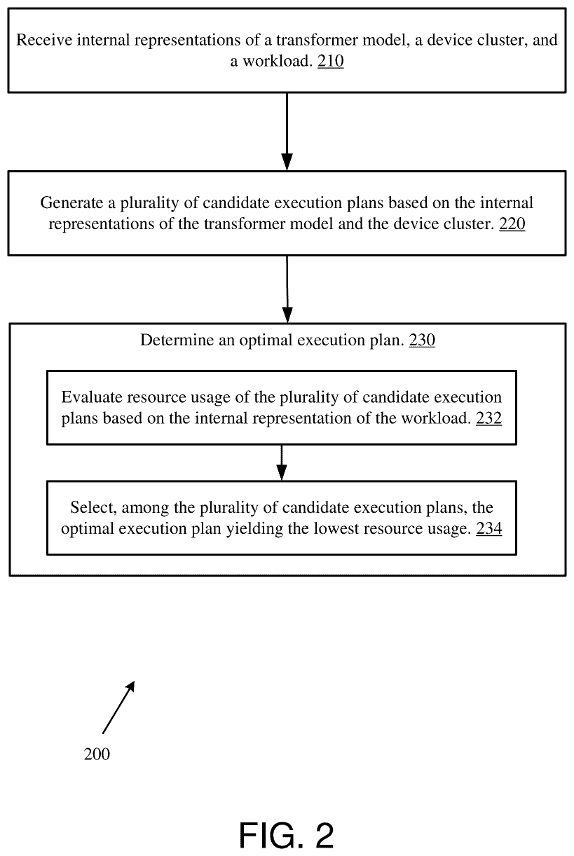

FIG. 2 is a flowchart illustrating an example overall method 200 for automatic determination of a parallel schedule for executing a given AI workload. The method 200 can be performed, e.g., by the computing system 100 of FIG. 1.

At step 210, the method can receive an IR of a transformer model (e.g., 110), an IR of a cluster model (e.g., 120), and an IR of a workload (e.g., 130) for execution of the transformer model on the device cluster.

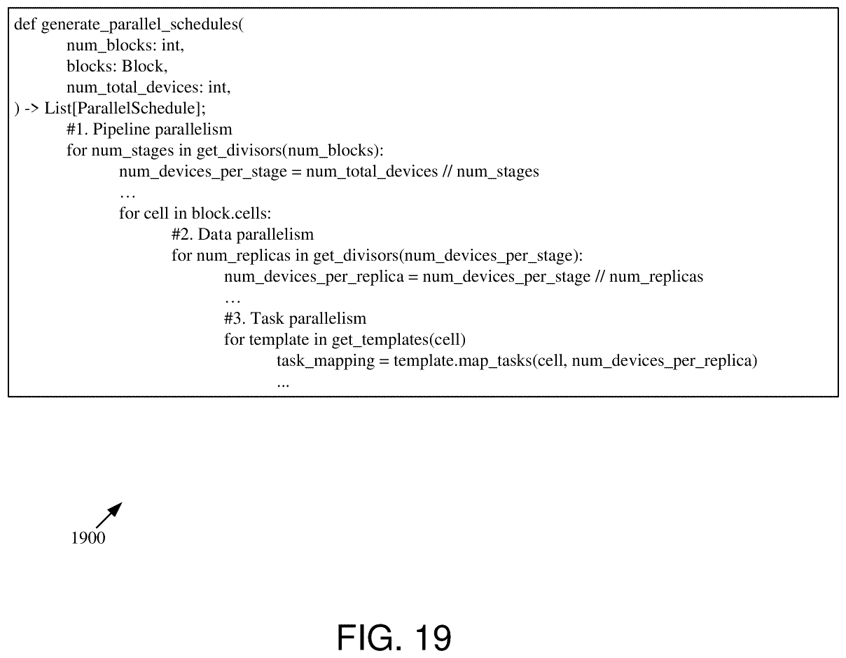

At step 220, the method can generate (e.g., using the search engine 140) a plurality of candidate execution plans (e.g., 150) based on the IR of the transformer model and the IR of the device cluster. Each candidate execution plan represents a unique parallel schedule for partitioning devices in the device cluster for parallel execution of the transformer model. In some examples, generating the plurality of candidate execution plans can be implemented by enumerating different combinations of multiple parallelisms, as described further below, e.g., in reference to FIG. 19 and the corresponding descriptions.

At step 230, the method can evaluate resource usage of the plurality of candidate execution plans (e.g., using the simulator 160) based on the IR of the workload. The evaluating can include simulating execution of the transformer model on the device cluster to process the workload. In some examples, evaluating resource usage of a selected candidate execution plan includes estimating a total processing time for the selected candidate execution plan to process all input requests in the workload. Additional details and examples of evaluating resource usage of candidate execution plans are described further below in the section titled “Example Simulation and Resource Usage Estimation.”

Then, at step 240, the method can determine an optimal execution plan which yields the lowest resource usage among the plurality of candidate execution plans. For instance, of all candidate execution plans, a candidate execution plan associated with the lowest total processing time can be determined to be the optimal execution plan.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “send” can also be described as “receive” from a different perspective.

### Example Overall Method for Executing a Parallel Schedule With Mixed Parallelisms

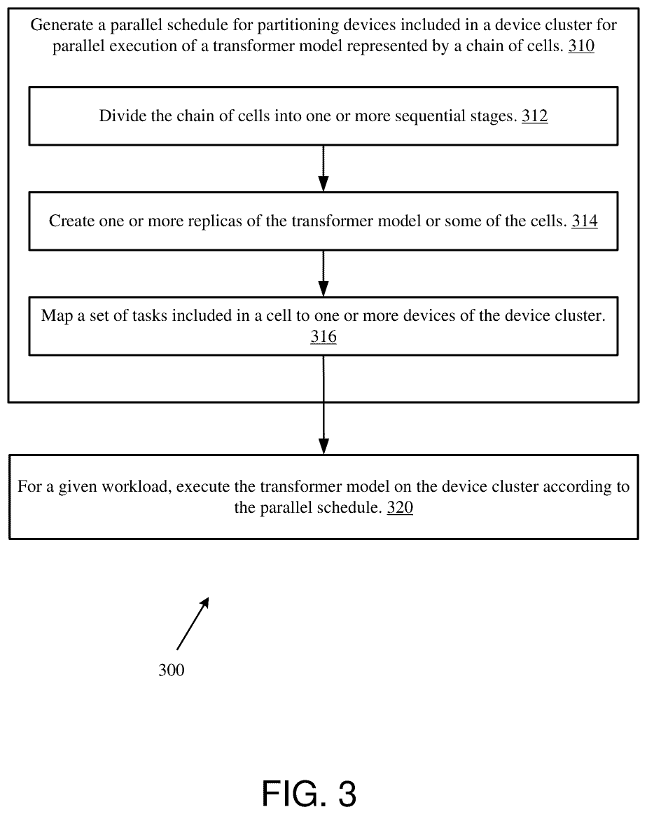

FIG. 3 is a flowchart illustrating an example overall method 300 for using a parallel schedule including mixed parallelisms for executing a given AI workload. The method 300 can be performed, e.g., by the computing system 100 of FIG. 1.

At step 310, the method can generate a parallel schedule for partitioning devices included in a device cluster for parallel execution of a transformer model. The transformer model can be represented by a chain of cells. Each cell includes a set of tasks of the transformer model.

At step 320, for a given workload, the method can execute the transformer model on the device cluster according to the parallel schedule.

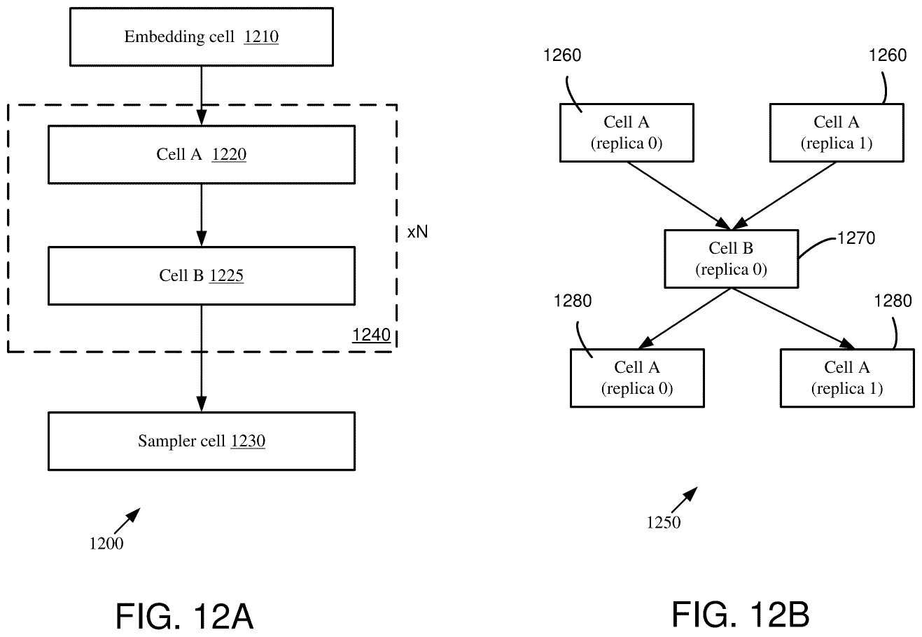

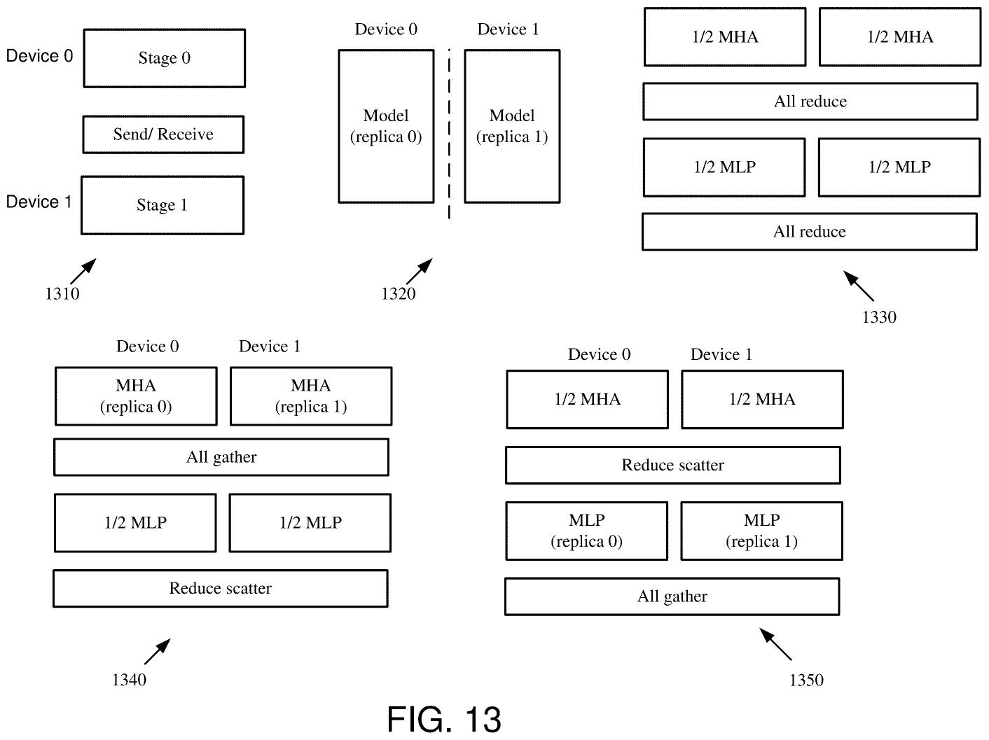

Generating the parallel schedule includes several sub-steps that combine multiple different types of parallelisms. For example, at step 312, the method can divide the chain of cells into one or more sequential stages (e.g., pipeline parallelism). At step 314, the method can create one or more replicas of the transformer model or some of the cells (e.g., data parallelism). At step 316, the method can map the set of tasks included in a cell to one or more devices of the device cluster (e.g., task parallelism). Examples of different types of parallelisms are illustrated below, e.g., in reference to FIGS. 12A-12B and FIG. 13 and the corresponding descriptions. Example methods for implementing the above sub-steps are described further below, e.g., in reference to FIG. 19 and the corresponding descriptions.

### Example Overall Method for Searching Parallel Schedules

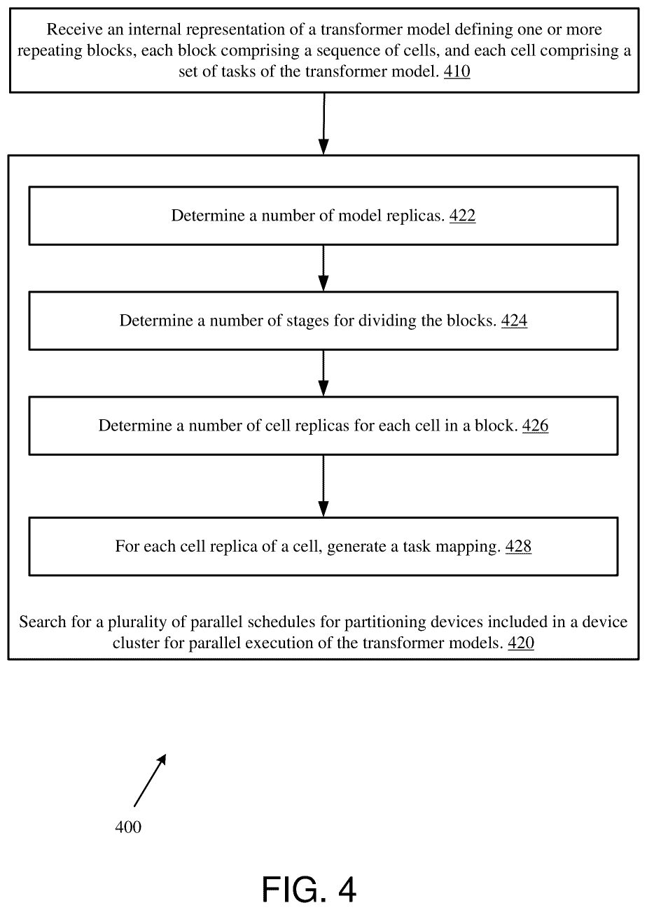

FIG. 4 is a flowchart illustrating an example overall method 400 for searching parallel schedules within a search space for execution of a given AI workload. The method 400 can be performed, e.g., by the computing system 100 of FIG. 1.

At step 410, the method can receive an IR of a transformer model, which defines one or more repeating blocks, each block including a sequence of cells, and each cell including a set of tasks of the transformer model.

Then, at step 420, the method can search for a plurality of parallel schedules for partitioning devices included in a device cluster for parallel execution of the transformer model. The searching can include the following sub-steps.

At step 422, the method can determine a number of model replicas. Each model replica represents a copy of the transformer model. Devices included in the device cluster can be partitioned into the number of model replicas. In some examples, the number of model replicas is a divisor of a count of devices included in the device cluster. Devices included in the device cluster can be evenly partitioned into the number of model replicas.

At step 424, the method can determine a number of stages that divide the one or more repeating blocks. Devices partitioned into each model replica can be partitioned into the number of stages. Each stage includes at least one block, and a stage can have multiple blocks. In some examples, the number of stages is a divisor of a count of devices partitioned into each model replica, and devices partitioned into each model replica can be evenly partitioned into the number of stages.

At step 426, the method can determine a number of cell replicas for each cell in a block. Each cell replica represents a copy of the corresponding cell. Devices partitioned into each stage can be partitioned into the number of cell replicas. In some examples, the number of cell replicas is a divisor of a count of devices partitioned into each stage, and devices partitioned into each stage can be evenly partitioned into the number of cell replicas.

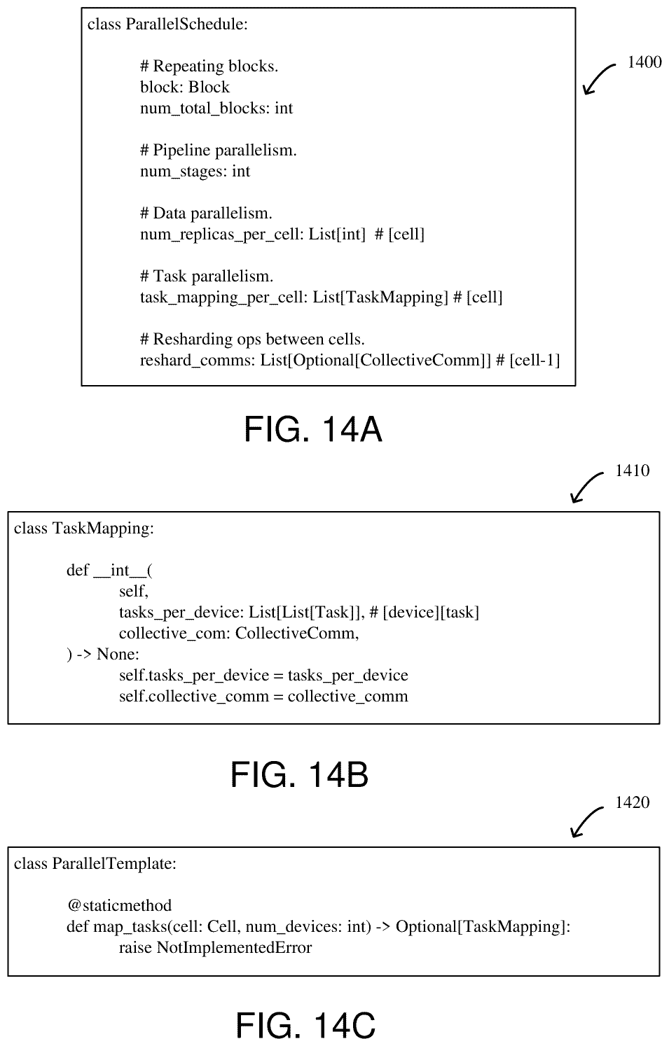

Then at step 428, for each cell replica of a cell, the method can generate a task mapping which maps the set of tasks included in the cell to devices partitioned into the cell replica. In some examples, generating the task mapping can include dividing the set of tasks included in the cell evenly or substantially evenly among devices partitioned into the cell replica, and determining a type of collective communications specific to the cell to synchronize outputs of the set of tasks that are divided among devices partitioned into the cell replica. As described more fully below, task mappings for a cell can be generated based on one or more registered parallel templates for the cell. An example software implementation for generating a task mapping is illustrated in FIG. 14B and the corresponding descriptions.

### Example Device Cluster

As described herein, a device cluster is a group of interconnected computing devices, such as graphics processing units (GPUs), that work together to perform parallel computing tasks. In the context of transformer models, which are often computationally intensive due to their large size and complexity, a device cluster can significantly speed up the training and inference processes. By distributing the computations across multiple devices in the cluster, it allows for simultaneous processing of different parts of the model or data. Such parallelism not only accelerates the overall computation time but also enables the handling of larger models and datasets that may not fit into the memory of a single device.

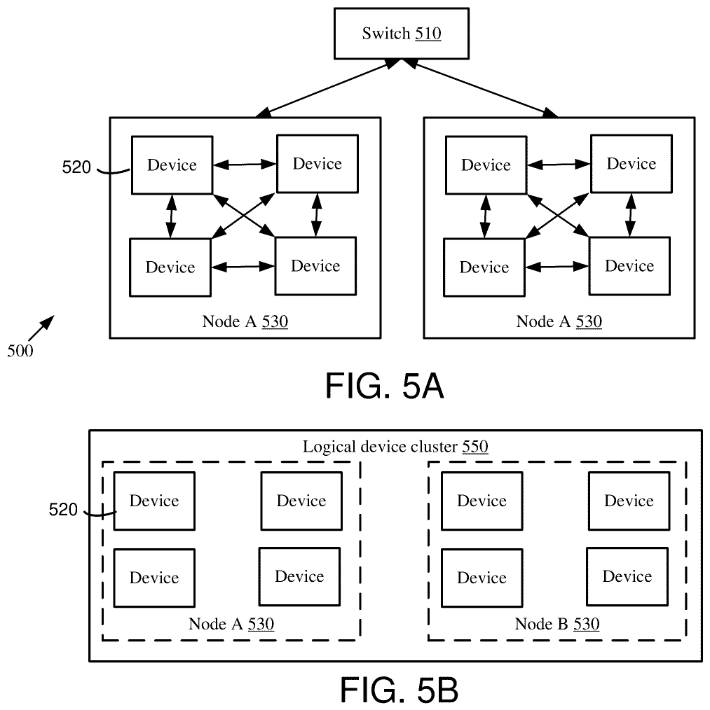

FIG. 5A shows a physical device cluster 500, which can have a hierarchical, tree-like structure composed of interconnected devices 520 and nodes 530. For simplicity, the devices 520 are considered to be homogeneous in terms of computation speed and memory capacity. Each node 530 can house multiple devices 520 (e.g., GPUs) that are interconnected. These devices 520 are the leaves of the tree-like structure and are responsible for carrying out the computational tasks. The nodes 530 can be connected to a switch 510, a networking device that channels incoming data from multiple input ports to the specific output port that will take the data toward its intended destination in the network. The bandwidths within a level are the same, while bandwidth across levels can be different. The physical device cluster 500 can have various network topologies, such as PCIe, which is commonly used for V100-PCIE-16GB GPUs, full-mesh NVLink for A100 GPUs, and a flat topology. These topologies define how the devices 520 and nodes 530 are interconnected, influencing the efficiency of data transfer and overall performance of parallel computing tasks.

FIG. 5B shows a logical device cluster 550 which can be considered as an internal representation of the physical device cluster 500 (such as the IR of the device cluster 120). The logical device cluster 550 abstracts away the actual devices by ignoring the underlying network topology, but still maintains the hierarchical relationship between devices 520 and nodes 530. This abstraction allows for a simplified view of the device cluster 500, focusing on the hierarchical relationships and computational capabilities of the devices 520, rather than the specifics of the network connections.

### Example Tasks and Cells

As described herein, a transformer model can have an internal representation (such as the IR of the transformer model 110) expressed as a chain of cells (in contrast to a directed acyclic graph structure), each containing multiple tasks that handle different computational requirements independently. In any of the examples described herein, the chain of cells can be used to represent any components of a transformer model such as an embedding layer (which converts input data into a form that can be processed by the model), an encoder (which transforms the input into a higher-level representation), a decoder (which converts the encoded data back into a more understandable form), and a sampler (which selects specific data points for processing).

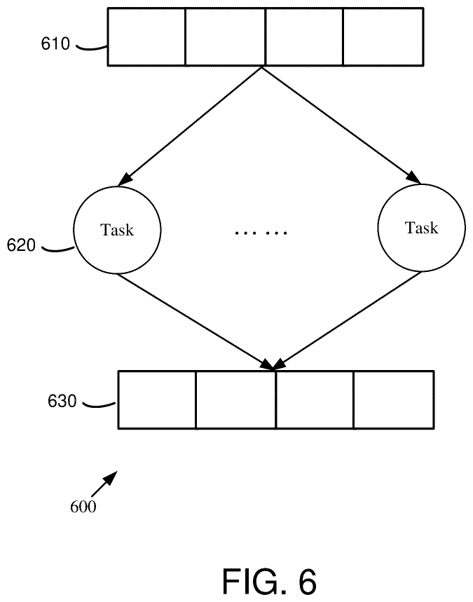

FIG. 6 schematically depicts an example structure of a cell 600 in a transformer model. The cell 600 includes a series of computational operations, or tasks 620. Tasks 620 within the cell 600 can be independent from one another and each task can carry out specific computations (e.g., having its own weights and computation requirements) on the input data.

The types of tasks 620 can vary and include operations performed by various neural networks such as multi-head attention (MHA) neural network (which uses multiple attention mechanisms to focus on different parts of the input), multi-query attention (MQA) neural network (which is variant of MHA that uses multiple queries but shares key and values across the heads to reduce computational complexity), multi-layer perception (MLP) neural network (which includes multiple layers of perceptrons for deep learning), gated linear unit (GLU) filter (which uses gating mechanisms to control the flow of information), and mixture of experts (MoE) neural network with MLP filters (which routes inputs to different expert networks for specialized processing), among others.

The cell 600 has an input activation 610, which is the initial layer in the cell 600 where data enters for processing. The data then flows through the various tasks 620 within the cell 600. In some examples, each task 620 can apply its specific computation to the complete data set of the input activation 610. Note that these tasks 620 are not part of the tensor, but they process the tensor data independently.

After the data has been processed by the tasks 620, it reaches an output activation 630, which is the final layer in the cell 600 where the processed data exits. The outputs from the various tasks 620 can be combined or “reduced” to form the final output activation 630. This output activation 630 can serve as the input to the next cell in the chain, allowing the transformer model to handle complex, sequential data processing tasks.

### Example Cell Types

The cell 600 can have different cell types based on the types of tasks 620 included therein. For example, the cell 600 can have an MHA cell type if the tasks 620 include MHA operations, or an MLP cell type if the tasks 620 include MLP operations, and so on. The cell 600 can also include different types of tasks 620. For example, the cell 600 can have a parallel MHA (or MQA) and MLP cell type if the tasks 620 include both MHA (or MQA) and MLP operations.

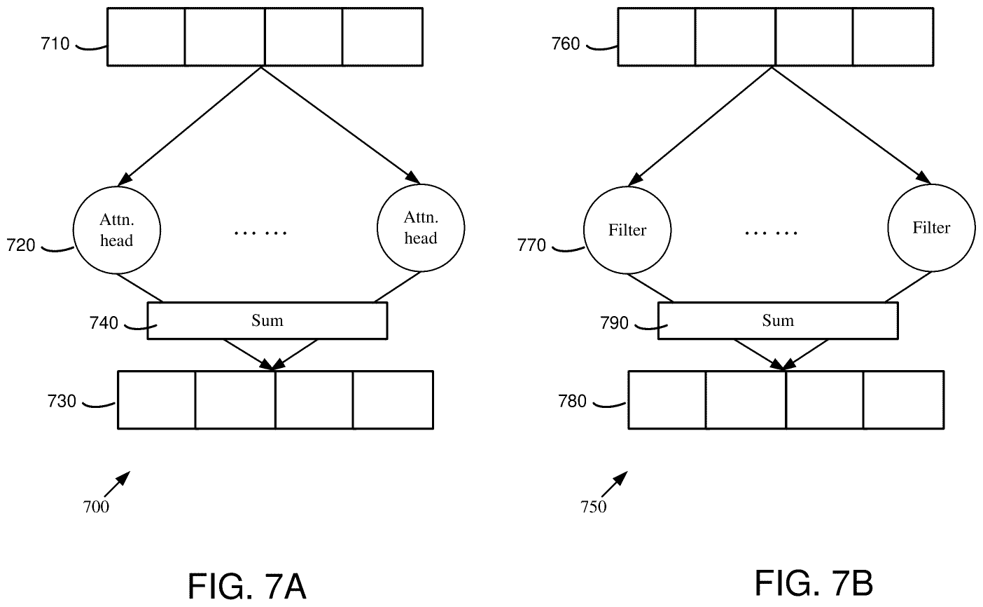

To illustrate, FIG. 7A schematically depicts an example structure of an MHA cell 700 in a transformer model. The MHA cell 700 has an input activation 710, an output activation 730, and a plurality of tasks 720 for MHA operations linking the input activation 710 to the output activation 730. The MHA allows the transformer model to focus on different positions of the input sequence when processing a particular position in the output sequence. This is achieved by using multiple “attention heads,” each of which independently computes a weighted sum of the input activation 710. As shown, each task 720 can be configured to implement one single attention head. Specifically, each task 720 processes the input activation 710 independently, focusing on different aspects of the input data. The outputs of these tasks 720 can then be combined, e.g., via a sum operator 740 (also referred to as “all-reduce” collective operation), in the output activation 730, effectively allowing the cell 700 to capture a richer set of features from the input data.

Similarly, FIG. 7B schematically depicts an example structure of an MLP cell 750 in a transformer model, which includes an input activation 760, an output activation 780, and a plurality of tasks 770 for MLP operations linking therebetween. The MLP operations involve a series of linear transformations and non-linear activations, which allow the model to learn complex patterns in the input data. Each task 770 in the MLP cell 750 can be seen as implementing an MLP filter, which applies a series of these transformations and activations to the input activation 760 independently. The outputs of these tasks 770 can be reduced via a sum operator 790 in the output activation 780.

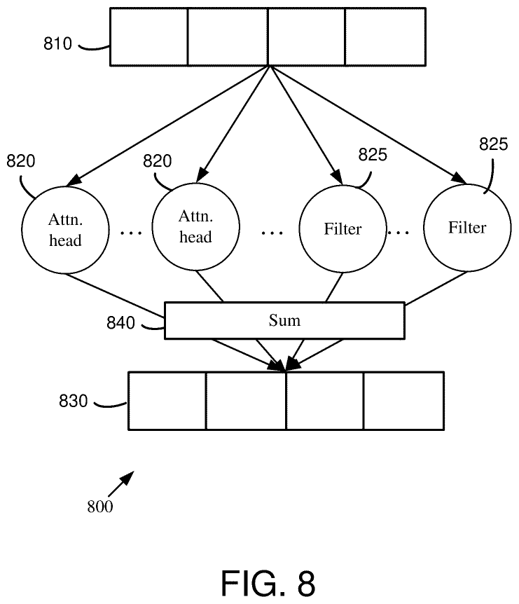

FIG. 8 schematically depicts an example structure of a parallel MHA and MLP cell 800 in a transformer model (such as PaLM V1, GPT-J, Dolly V2, Falcon, etc.). The cell 800 includes an input activation 810, an output activation 830, and two types of tasks: MHA tasks 820 and MLP tasks 825. These tasks operate in parallel, each processing the input activation 810 independently. In this example, each MHA task 820 can represent a single attention head and each MLP task 825 can represent an MLP filter. The outputs of both the MHA tasks 820 and MLP tasks 825 can be aggregated or reduced via a sum operator 840 in the output activation 830.

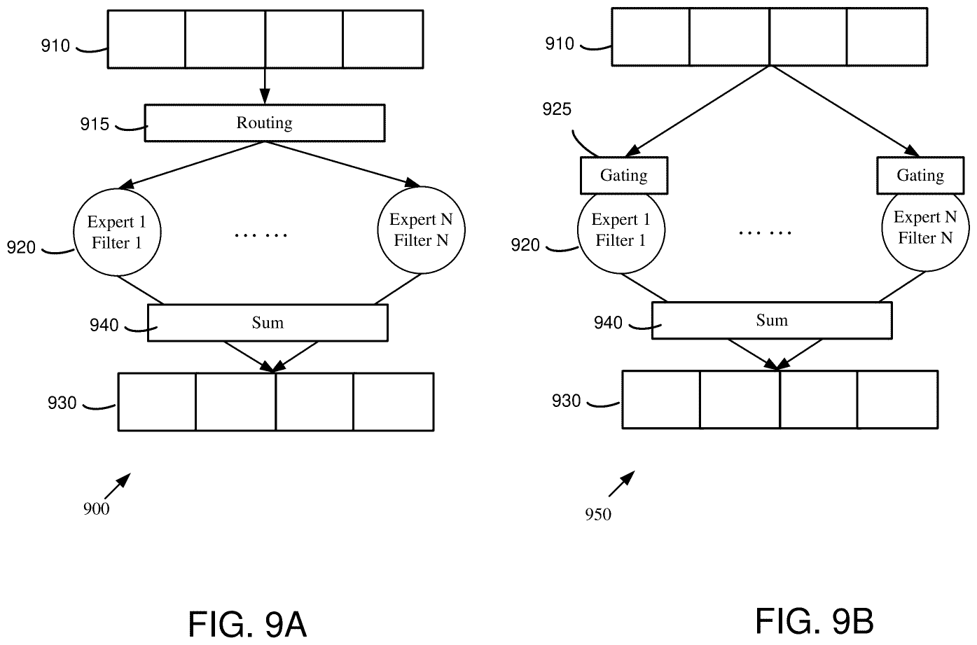

FIG. 9A schematically depicts an example structure of a mixture of experts (MoE) cell 900 in a transformer model. The MoE cell 900 includes an input activation 910, an output activation 930, and a plurality of tasks 920 for MoE operations linking therebetween. The MoE involves distributing, via a routing logic 915, different parts of an input among various experts within a network, each specializing in processing certain types of information. Each task in this MoE cell 900 represents a filter in one expert, and the outputs of these tasks 920 (active experts) can be reduced via a sum operator 940 in the output activation 930.

FIG. 9B depicts another example structure of an MoE cell 950 transformed from the structure of the MoE cell 900. Such transformation involves removing the routing logic 915 and adding individual gating logic 925 to each expert. The routing logic 915, previously centralized, is now replicated within each expert's gate, which independently decides whether the expert should process a given input part (i.e., the gating logic 925 evaluates the input and activates the expert based on a learned or predefined criterion). This decentralized approach may result in more efficient and balanced utilization of experts and improve scalability.

Here, each task 920 in the MoE cell 950 represents a filter in an expert plus a corresponding gating logic 925. Similarly, the outputs of active experts are then aggregated in the output activation 930.

### Example Internal Representations of Transformer Models

In some examples, an internal representation of transformer model (such as the IR of the transformer model 110) can define one or more repeating blocks, and each block can define a sequence of cells. As described herein, an upstream cell refers to a cell that precedes another cell in the sequence, passing its output as input to the subsequent cell. Conversely, a downstream cell is a cell that receives input from an upstream cell, processing this input to produce its own output, which may be further passed along the sequence.

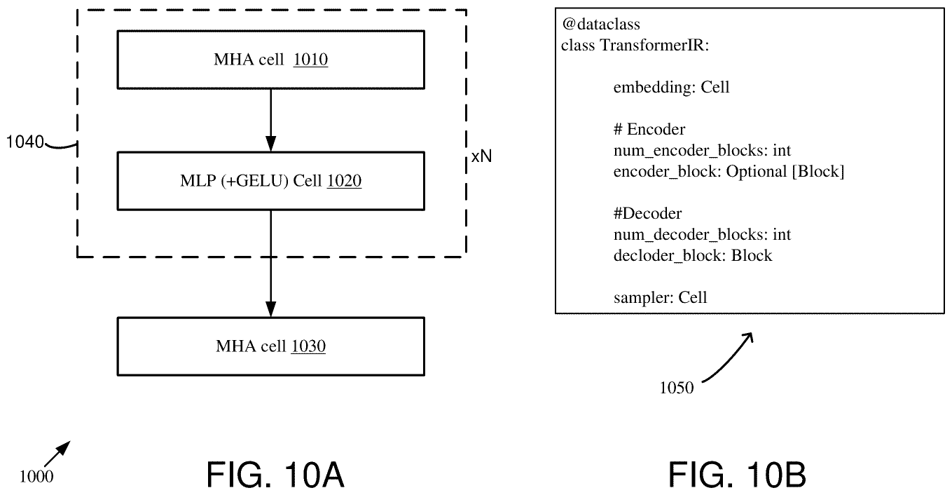

For example, FIG. 10A schematically depicts an example structure of a GPT-2 transformer model 1000 which includes a MHA cell 1010, an MLP cell 1020 (including a Gaussian error linear unit, or GELU), and another MHA cell 1030 that are arranged in a sequence. As shown, two adjacent cells, MHA cell 1010 and MLP cell 1020, can form a block 1040, which can be repeated multiple times (denoted by ×N). This repeating block structure allows the transformer model 1000 to scale up and handle more complex tasks by stacking multiple instances of the same basic computational units (e.g., MHA cell 1010 and MLP cell 1020), thereby enhancing the depth and capacity of the model without introducing new types of operations or parameters.

FIG. 10B depicts pseudo-code definition of a class for internal representation 1050 of a transformer model. The class, named “TransformerIR,” outlines the structure and configuration of the transformer model, including an encoder block, a decoder block, the repeating numbers of these blocks, and types of cells used in these blocks. The class can also define specific cells for the embedding layer and the sampler which are outside the blocks.

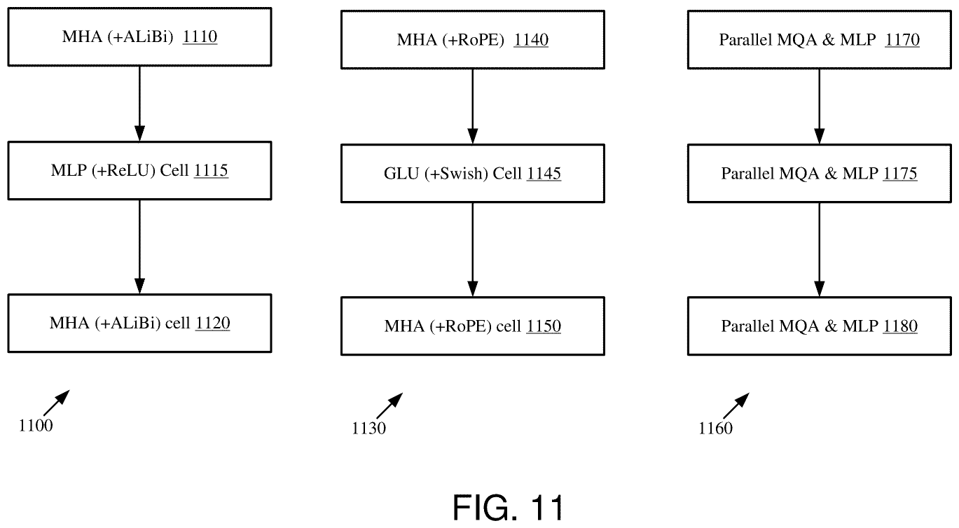

The internal representation 1050 can be used to define a variety of transformer models such as the GPT-2 transformer model 1000. For instance, FIG. 11 schematically depicts structures of three additional transformer models 1100, 1130, and 1160, which can be defined by the internal representation 1050. The transformer model 1100 (as in BLOOM transformer model) includes an MHA cell 1110 (using attention with linear biases, or ALiBi, for position embedding), an MLP cell 1115 (with a rectified liner unit, or ReLU), and another MHA cell 1120 (using ALiBi for position embedding). The transformer model 1130 (as in LLaMA transformer model) includes an MHA cell 1140 (with rotary positional embedding, or RoPE), a GLU cell 1145 (with swish activation), and another MHA cell 1150 (with RoPE). The transformer model 1160 (as in Falcon transformer model) includes consecutive parallel MQA and MLP cells 1170, 1175, and 1180. As described above, a set of cells that are repeated can be included in a block. For example, the transformer model 1160 can define a repeating block that includes the parallel MQA and MLP cell 1170.

### Example Types of Parallelisms

As described herein, given an internal representation of a transformer model and an internal representation of a device cluster model, multiple types of parallelism can be employed to construct a parallel schedule (as a candidate execution plan) for partitioning devices in the device cluster for parallel execution of the transformer model.

One type of parallelism is pipeline parallelism, which partitions one or more repeating blocks of a transformer model into one or more pipeline stages (or simply, “stages”). In some examples, each pipeline stage has the same or substantially the same number of blocks. Devices in a device cluster can be partitioned into the one or more pipeline stages. In some examples, the devices are evenly or substantially evenly partitioned by the number of pipeline stages. Pipeline parallelism can improve efficiency by allowing different stages of a task to be processed concurrently. This can be achieved by dividing the input data into smaller subsets, also referred to as micro-batches (e.g., user's prompt can be divided into smaller chunks). Each micro-batch can then be processed independently in a different pipeline stage. For example, while one micro-batch is being processed in one stage, another micro-batch can simultaneously be processed in a different stage. This concurrent processing of data reduces idle time and ensures that all devices in the device cluster are utilized effectively.

FIG. 12A schematically illustrates pipeline parallelism in an example transformer model 1200 which includes an embedding cell 1210, a sampler cell 1230, and a block 1240 linking the embedding cell 1210 and the sampler cell 1230. In this example, the block 1240 contains two cells (e.g., cell A 1220 and cell B 1225) and is repeated for N times. For the pipeline parallelism, the N repeating blocks 1240 can be divided into two or more pipeline stages that will be processed in sequence. For example, if N is eight, then the pipeline parallelism can configure two pipeline stages, each containing four repeating blocks 1240, or four pipeline stages, each containing two repeating blocks. In some examples, each pipeline stage can be assigned the same number of devices in a device cluster.

Another type of parallelism is data parallelism, which creates one or more replicas of the transformer model or some of the cells. In some examples, the transformer model itself can be duplicated to create two or more model replicas (hereinafter “model-level data parallelism”), each receiving an equal amount of resources from the device cluster (e.g., the devices in the device cluster are evenly portioned among the model replicas). Each model replica can process a portion of the input, and the output of these model replicas can be concatenated to generate the final model output. As described herein, the transformer model is deemed to have a single model replica if the transformer model is not duplicated.

In some examples, a selected cell of a transformer model can be duplicated to create two or more cell replicas (hereinafter “cell-level data parallelism”). As described herein, a cell is deemed to have a single cell replica if the cell is not duplicated. An example is shown in FIG. 12B, which schematically illustrates an example transformer model 1250 including three cells arranged in a sequence. Specifically, output of an upstream cell A 1260 is sent to cell B 1270, whose output is sent to another downstream cell A 1280. In this example, the upstream cell A 1260 is duplicated to create two cell replicas (e.g., replica 0 and replica 1), and their output are combined as an input the cell B (not duplicated, denoted as a single replica 0). The downstream cell A 1280 is also duplicated to create two replicas (e.g., replica 0 and replica 1), and the output of cell B 1270 is distributed to both replicas of the downstream cell A 1280. Devices partitioned for upstream cell A 1260 can be evenly divided between its two replicas. Similarly, devices partitioned for the downstream cell A 1280 can be evenly divided between its two replicas.

Another type of parallelism is task parallelism. Task parallelism maps tasks in a cell to multiple devices in a device cluster. In other words, each device independently performs a subset of the tasks in the cell. This can be implemented, e.g., by partitioning the cell into multiple sub-cells, each handled by a different device. Once all devices have completed their tasks, the results are aggregated. In some examples, task parallelism includes tensor parallelism, which is implemented by splitting tensors, which are multi-dimensional arrays of data, into smaller sub-tensors, and distributing the resulting sub-tensors across multiple devices in a device cluster for parallel processing, and each device performs the same operation independently on its portion of the tensor. For instance, for an MHA cell, the tasks of processing different attention heads can be parallelized by distributing them across multiple devices. Each device handles a subset of the heads, processes its assigned portion of the data, and then the results are combined to form the final output. Additionally, task parallelism can also include expert parallelism, which can split multiple experts in an MoE cell across different devices, where each device processes a subset of the tasks involved in the MoE cell.

Generally, task parallelism can reduce single-batch latency (the time needed to process a single batch of data from the start of the computation to the end) through concurrent execution of tasks. Instead of sequentially handling the entire computation on a single device, task parallelism splits the tasks/data into smaller parts, each processed simultaneously on different devices. This parallel execution decreases the total time required to process the batch, leading to faster overall computation and reduced latency. Further, task parallelism can also allow the handling of larger models that exceed the memory capacity of a single device. However, task parallelism generally requires a higher collective communication overhead coordinate and synchronize the tasks across different devices, which may potentially offset the benefits of task parallelism in some circumstances.

Pipeline parallelism does not reduce single-batch latency but may have higher throughput since the communication overhead is smaller because data exchange mainly occurs between adjacent pipeline stages, reducing the need for extensive coordination across multiple devices. Pipeline parallelism can be beneficial when dealing with large transformer models, as it allows for larger memory space for intermediate activations, thereby enabling or large batch sizes, which can lead to higher throughput. However, it may still introduce some modest communication overhead due to the need to send and receive data between adjacent pipeline stages.

On the other hand, data parallelism can be effective when weights of the transformer model can be stored in the device memory. The model-level data parallelism has no collective communication overhead. The cell-level data parallelism requires all-gather or reduce-scatter collective communication, both of which are computationally less intensive than all-reduce collective communication. However, data parallelism may limit the batch size because it splits the batch dimension and replicates the weights, thereby reducing the memory available for activations.

Thus, the choice between pipeline parallelism, data parallelism, and task parallelism may depend on multiple factors such as the specific user requests, the size of the model, and the available computational resources.

### Example Parallel Schedules

As described herein, a parallel schedule can be constructed using one, two, or more than two types of parallelisms, such as pipeline parallelism, data parallelism, and task parallelism (including both tensor parallelism and expert parallelism). These parallelisms can be combined in various ways to optimize performance. For example, pipeline parallelism allows different stages of a transformer model to be processed concurrently. Data parallelism, on the other hand, manages large data sets by distributing them across multiple devices. Task parallelism enables the simultaneous execution of different tasks. The optimal mix of these parallelism types can vary, and the automatic partition framework disclosed herein is designed to analyze the workload, the transformer model, and the device cluster, and then determine the most effective combination of pipeline, data, and task parallelisms. An example implementation of a nested loop search algorithm which enumerates all possible parallel schedules that combine different types of parallelisms is described further below in reference to FIG. 19 and the corresponding descriptions.

FIG. 13 presents five illustrative parallel schedules for a transformer model. These examples are not exhaustive, but rather serve to demonstrate the potential configurations that can be achieved by combining different types of parallelisms. In these examples, it is assumed that the transformer model includes a repeating block containing an MHA cell followed by an MLP cell. For simplicity, it is also assumed that the device cluster includes only two devices: Device 0 and Device 1.

In the first parallel schedule 1310, pipeline parallelism is utilized exclusively. The repeating block is partitioned into two sequential stages (Stage 0 and Stage 1), with each stage being processed on a different device. Specifically, Stage 0 is processed on Device 0 while Stage 1 is processed on Device 1. Overhead involves communications between the two stages, e.g., Device 1 receives its input to Stage 1 from Device 0, which sends output data from Stage 0.

In the second parallel schedule 1320, model-level data parallelism is employed. The entire transformer model is replicated across both devices. This means that Device 0 and Device 1 each have a complete copy of the transformer model, allowing them to process different data sets simultaneously (e.g., the input data is split in half and each half is processed independently by each device).

The third parallel schedule 1330 uses tensor parallelism exclusively. It splits the tasks of both the MHA cell and the MLP cell in half (thus creating two MHA half cells and two MLP half cells), with each half being executed on a different device. Specifically, half of the tasks of the MHA cell and the MLP cell are executed on Device 0, and the other half are executed on Device 1. The parallel schedule 1330 employs collective communications between the cells to synchronize the tasks executed on different devices. Specifically, all-reduce collective communications are used to combine outputs from the two MHA half cells as well as outputs from the two MLP half cells to maintain coherence in parallel processing.

Both the fourth parallel schedule 1340 and the fifth parallel schedule 1350 combine cell-level data parallelism and tensor parallelism.

In the parallel schedule 1340, the MHA cell is replicated across both devices (cell-level data parallelism), and the MLP cell is split in half (tensor parallelism). Specifically, Device 0 and Device 1 each have a complete copy of the MHA cell. After the two MHA cell replicas process their respective data, an all-gather collective communication is employed to synchronize the outputs from the MHA cell replicas across the two devices. Subsequently, the tasks of the MLP cell are split between the two devices. After the two MLP half cells process their respective tasks, the reduce-scatter collective communication is used to combine the outputs from the MLP half cells, ensuring coherence in parallel processing.

Conversely, in the parallel schedule 1350, the MLP cell is replicated across both devices (cell-level data parallelism), and the MHA cell is split in half (tensor parallelism).

Specifically, the tasks of the MHA cell are split between the two devices. After the two MHA half cells process their respective tasks, a “reduce scatter” collective communication is used to synchronize the outputs from the two devices. Subsequently, each device processes its respective copy of the MLP cell independently. After the MLP cell replicas process their respective data, an all-gather collective communication is employed to synchronize the outputs from the MLP cell replicas across the devices.

FIG. 14A depicts pseudo-code definition of an example class 1400 for parallel schedules. The class 1400, named “ParallelSchedule,” includes several attributes that define how pipeline parallelism, data parallelism, and task parallelism are applied to a transformer model. For example, the class 1400 defines repeating blocks within the transformer model, number of stages (for pipeline parallelism), number of cell replicas for each cell in a list of cells (cell-level data parallelism), and a list of task mapping objects for selected cells (task parallelism). The class 1400 also defines a list of ‘CollectiveComm’ objects, representing resharding operations between cells. The resharding objects may be optional depending on whether adjacent cells have different number of cell replicas. Although not shown, in some examples, the class 1400 can also define the number of model replicas (model-level data parallelism). Task mapping objects and resharding operations are described further below.

### Example Task Mapping

As described above, task parallelism maps tasks to logical devices in a device cluster. FIG. 14B depicts pseudo-code definition of an example class 1410 for task mapping objects. The class 1410, named “TaskMapping,” has two parameters: tasks_per_device, a list of lists containing ‘Task’ objects, and collective_comm, an object of type ‘CollectiveComm’. The former defines how the tasks are mapped to logical devices, and the latter defines which type of collective communication (e.g., all-reduce, all-gather, all-to-all, etc.) should be used to synchronize the outputs of the individual tasks. As described further below, task mappings for a cell can be generated based on the registered parallel templates for the cell.

In some examples, the task mapping in the disclosed automatic partition framework can be configured to handle cases where the number of tasks is not divisible by the number of devices. For instance, if an MHA cell with 52 heads needs to be mapped to 8 devices, the task mapping can assign 7 MHA heads to 4 devices and 6 MHA heads to the other 4 devices. This flexible assignment ensures that each device is assigned at least one task while attempting to achieve as uniform a task distribution as possible.

### Example Parallel Templates

In some examples, each cell type is associated with one or more pre-defined parallel templates. Each parallel template defines a predefined task mapping scheme for dividing tasks of a cell having the corresponding cell type among a given number of devices in the device cluster. A parallel template can be implemented as a function which takes as input a cell and the number of devices assigned to the cell and returns a task mapping object, e.g., an instance of the TaskMapping class 1410. Because the TaskMapping class encapsulates both the task distribution and the collective communication strategy, each parallel template also defines a corresponding type of collective communications for synchronizing outputs of the tasks divided among the given number of devices.

For instance, FIG. 14C depicts pseudo-code definition of an example class 1420 for parallel templates. The class 1420, named “ParallelTemplate,” includes a static method ‘map_tasks’ that takes two input parameters that respectively represents a cell of a specific cell type and the number of devices assigned to the cell. This method can return a TaskMapping object, which represents a pre-registered or predefined task mapping scheme for the specific cell type.

The parallel templates for different cell types can be configured to balance the computational and memory overheads across each device. These parallel templates can be configured to distribute tasks as evenly as possible among the devices for each type of task. It's important to note that the parallel templates described below are merely illustrative examples. Other parallel templates can be devised to meet specific requirements or to optimize performance under different conditions.

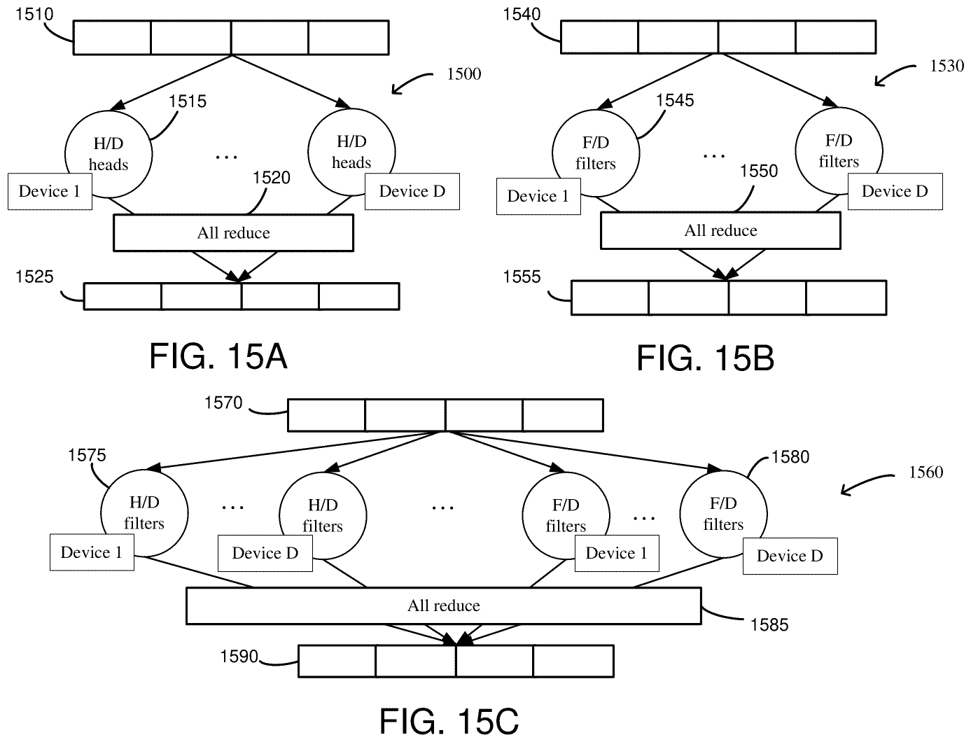

FIG. 15A illustrates an example parallel template 1500 for an MHA cell, which includes an input activation 1510, followed by a plurality tasks 1515 to process the attention heads, the outputs of which are synchronized via all-reduce collective communications 1520 and then sent to an output activation 1525. In this example, H attention heads are evenly distributed to D devices. As a result, each device independently processes H/D heads. For simplicity, it is assumed that H is a multiple of D, so each device handles an equal number of heads. In cases where H is not divisible by D, the distribution of heads to devices can still be made as approximately even as possible, as described above.

FIG. 15B illustrates an example parallel template 1530 for an MLP cell, which includes an input activation 1540, followed by a plurality of tasks 1545 implementing MLP filters. The outputs of these tasks are synchronized via all-reduce collective communications 1550 and then sent to an output activation 1555. In this example, F MLP filters are evenly distributed to D devices. As a result, each device independently processes F/D filters. For simplicity, it is assumed that F is a multiple of D, so each device handles an equal number of MLP filters. In cases where F is not divisible by D, the distribution of MLP filters to devices can still be made as approximately even as possible, as described above.

FIG. 15C illustrates an example parallel template 1560 for a parallel MHA and MLP cell, which includes an input activations 1570, followed by a plurality of tasks 1575 and 1580 to process the attention heads and MLP filters respectively. The outputs of these tasks are synchronized via all-reduce collective communication 1585 and then sent to an output activation 1590. In this example, each device is assigned H/D attention heads and F/D MLP filters. As a result, each device independently processes both H/D heads and F/D filters. For simplicity, it is assumed that both H and F are multiples of D, so each device handles an equal number of heads and filters. In cases where either H or F is not divisible by D, the distribution of heads and filters to devices can still be made as approximately even as possible, as described above.

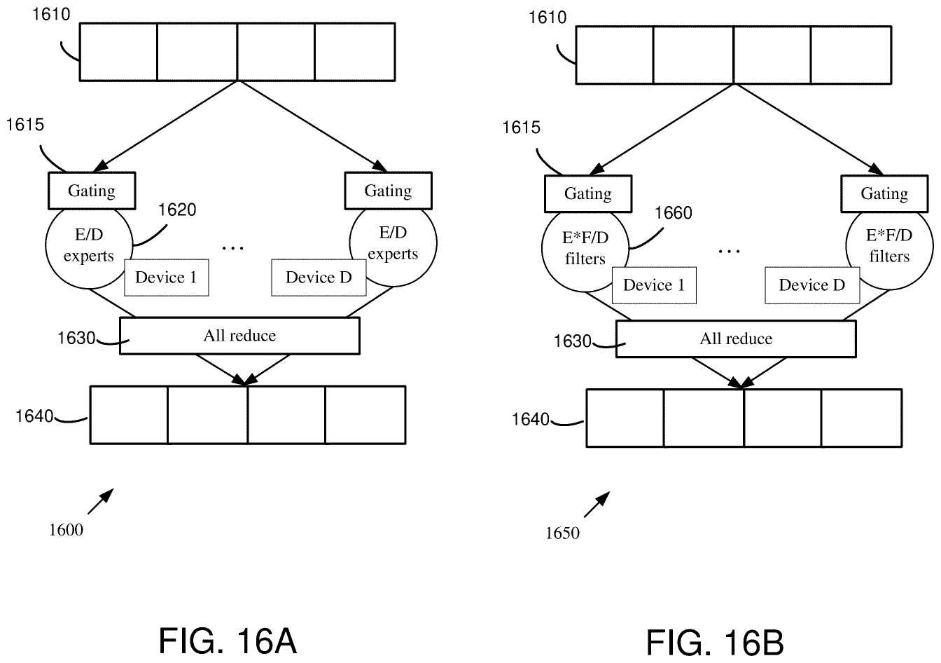

FIG. 16A illustrates an example parallel template 1600 for an MoE cell, which includes an input activation 1610, followed by a plurality of tasks 1620 to implement MoE (including gating logic 1615 for respective experts). The outputs of these tasks are synchronized via all-reduce collective communications 1630 and then sent to an output activation 1640. In this example, E experts are evenly distributed to D devices. As a result, each device is assigned E/D experts. For simplicity, it is assumed that E is a multiple of D, so each device has an equal number of experts. In cases where E is not divisible by D, the distribution of experts to devices can still be made as approximately even as possible, as described above.

FIG. 16B illustrates another example parallel template 1650 for the MoE cell, which includes the input activation 1610, followed by a plurality of tasks 1660 implementing MoE filters (including gating logic 1615 for respective experts). The outputs of these tasks are synchronized via all-reduce collective communications 1630 and then sent to the output activation 1640. In this example, E×F MoE filters are evenly distributed to D devices. In other words, each device is assigned F/D filters of all experts. For simplicity, it is assumed that the product E×F is a multiple of D, so each device handles an equal number of MoE filters. In cases where E×F is not divisible by D, the distribution of MoE filters to devices can still be made as approximately even as possible, as described above.

### Example Resharding Operations

Resharding is a process of redistributing data across a set of devices to meet the requirements of subsequent operations. Because the disclosed automatic partition framework allows each cell to have different numbers of cell replicas and have different task mapping, the intermediate tensor between two adjacent cells should be resharded by collective communication (including gating) if these two adjacent cells have different number of cell replicas. Specifically, the framework can trigger the resharding process when it identifies adjacent cells with differing numbers of cell replicas. Then, it applies collective communication methods, such as all-gather or gating operations, to redistribute the data between these cells. This redistribution ensures that each cell has the necessary data for its subsequent operations, taking into account the specific number of cell replicas it contains.

For instance, in the example depicted in FIG. 12B, both the upstream cell A 1260 and the downstream cell A 1280 have two cell replicas, whereas the cell B 1270 positioned therebetween has only one cell replica. Therefore, resharding is needed between upstream cell A 1260 and the cell B 1270, as well as between cell B 1270 and the downstream cell A 1280.

For each parallel schedule, resharding rules can be applied to select appropriate type of collective communication between adjacent cells that have different numbers of cell replicas. These rules ensure that data is correctly distributed and accessible for efficient processing in the subsequent stage, maintaining the efficiency and effectiveness of computational processes in a distributed computing environment.

One example resharding rule pertains to the scenario where two adjacent cells, an upstream cell with A cell replicas and a downstream cell with B cell replicas, are involved and A is a multiple of B (i.e., A=n×B, where n is an integer that is greater than 1). In this case, the resharding operations are all-gather operations. These operations collect outputs of the A cell replicas of the upstream cell and distribute them among the B cell replicas of the downstream cell. This ensures that all devices have the complete dataset for subsequent operations, thereby facilitating efficient data processing.

Another example resharding rule applies when the upstream cell has A cell replicas and the downstream cell has B cell replicas, and B is a multiple of A (i.e., B=n×A, where n is an integer that is greater than 1). Here, the resharding operations are gating operations.

These operations discard at least some outputs of the A cell replicas of the upstream cell and distribute the remaining outputs to the B cell replicas of the downstream cell. This selective discarding of data aligns with the configuration of the next cell, ensuring that data is correctly distributed and accessible for efficient processing in the subsequent stage.

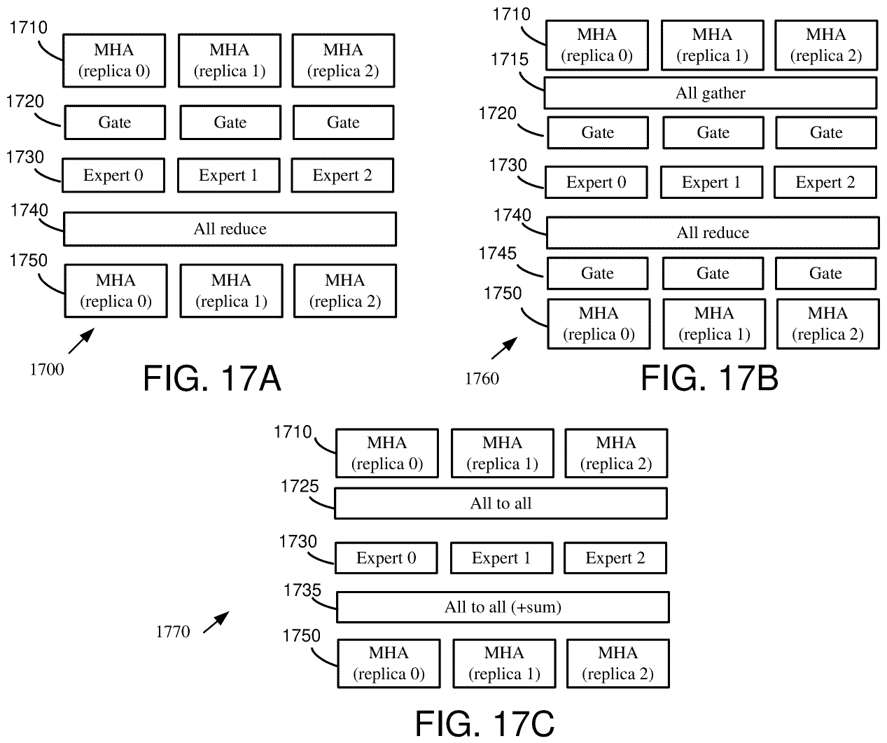

As an example, FIG. 17A schematically illustrates a parallel schedule 1700 including an upstream MHA cell 1710 having three cell replicas, an MoE cell 1730 (with three experts) having a single cell replica, and a downstream MHA cell 1750 having three cell replicas.

Each expert in the MoE cell 1730 has a corresponding gating logic 1720. Additionally, all-reduce collective communication 1740 is applied between the MoE cell 1730 and the downstream MHA cell 1750 to aggregate the outputs from the three experts and distribute them evenly across the cell replicas of the downstream MHA cell 1750.

FIG. 17B schematically illustrates an updated parallel schedule 1760 in which all-gather collective communication 1715 is added between the upstream MHA cell 1710 and the MoE cell 1730 because the number of cell replicas in the upstream MHA cell 1710 is three times that of the MoE cell 1730. The all-gather operation collects outputs from all cell replicas of the upstream MHA cell 1710 and ensures that each expert, via respective gating logic 1720, can have the complete dataset for subsequent operations. Additionally, gating logics 1745 are added between the MoE cell 1730 and the downstream MHA cell 1750 because the number of cell replicas in the downstream MHA cell 1750 is three times that of the MoE cell 1730. The gating logics 1745 selectively discards some outputs from the MoE cell 1730, after all-reduce collective communication 1740, and distributes the remaining outputs to the cell replicas of the downstream MHA cell 1750.

In some examples, resharding operations can be optimized by combining certain collective communications and gating logics into a single all-to-all collective communication to streamline data transfer. For example, FIG. 17C schematically illustrates a parallel schedule 1770 simplified from the parallel schedule 1760. As shown, the all-gather collective communication 1715 and the gating logics 1720 can be combined into an all-to-all collective communication 1725. In the all-gather operation, data from different sources is collected and combined at each destination, while the gating operation selectively filters or routes this data. By replacing these steps with an all-to-all operation, each process directly sends and receives only the relevant portions of data to and from all other processes, effectively integrating data collection and routing in one step, thereby reducing the overall communication overhead. Similarly, the all-reduce collective communication 1740 and gating logics 1745 can be combined into an all-to-all collective communication (with sum) 1735. This integration allows for a summation operation to be performed during the data transfer process, which consolidates outputs from multiple sources and distributes the summed result to each destination within a single step, thereby reducing the overall communication overhead.

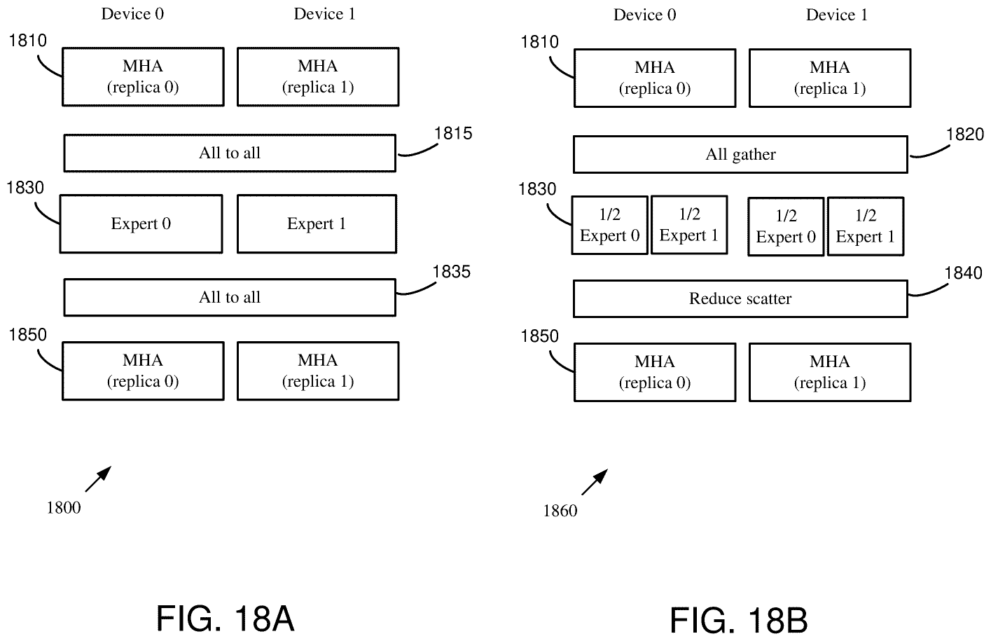

To further illustrate, FIG. 18A schematically illustrates a parallel schedule 1800 including an upstream MHA cell 1810 having two cell replicas, an MoE cell 1830 (with two experts) having a single cell replica, and a downstream MHA cell 1850 having two cell replicas. Similar to the example depicted in FIG. 17C, an all-to-all collective communication 1815 is added between the upstream MHA cell 1810 and the MoE cell 1830 (replacing all-gather collective communication and gating logics), and another all-to-all collective communication 1835 is added between the MoE cell 1830 and the downstream MHA cell 1850 (replacing all-reduce collective communication and gating logics). In this example, the MoE cell 1830 is associated with a parallel template which assigns the two experts to two devices (Device 0 and Device 1), respectively, similar to the parallel template 1600 of FIG. 16A.

FIG. 18B schematically illustrates another parallel schedule 1860 having the same upstream MHA cell 1810, the MoE cell 1830, and the downstream MHA cell 1850. However, in this example, the MoE cell 1830 is associated with a different parallel template which assigns each device one half of each expert, similar the parallel template 1650 of FIG. 16B. Here, an all-gather collective communication 1820 is applied after the upstream MHA cell 1810, and a reduce-scatter collective communication 1840 is applied after the MoE cell 1830. Neither all-gather nor reduce-scatter operation is combined with gating logics (omitted for simplicity) in this case.

### Example Parallel Schedule Search Space

As described above, given a transformer model and a device cluster, the disclosed automatic partition framework can search possible parallel schedules representing different candidate execution plans (e.g., via the search engine 140 of FIG. 1) within a search space, e.g., using the method 400 of FIG. 4. Specifically, a nested loop search algorithm can be used to systematically explore all possible configurations of combining multiple types of parallelisms for distributing an AI workload across a cluster of devices. In some examples, the nested loop search algorithm involves an outermost loop which identifies all possible numbers of model replicas (model-level data parallelism). For each model replica, the nested loop search algorithm can iterative over possible numbers of pipeline stages (pipeline parallelism), then determine possible numbers of cell replicas for each cell in the block (cell-level data parallelism). Additionally, the nested loop search algorithm can generate a task mapping for each cell replica (task parallelism).

FIG. 19 depicts pseudo-code implementation of an example function 1900, named “generate_parallel_schedules,” which is configured to generate potential or candidate parallel schedules. The function 1900 takes three input parameters which respectively specify the number of repeating blocks (“num_blocks”) in a transformer model, a block object (“block”) which defines a sequence of cells), and the total number of devices in a device cluster (“num_total_devices”). The function 1900 uses a nested loop approach for searching possible parallel schedules within a multi-dimensional search space: an outer loop for pipeline parallelism, two intermediate loops for data parallelism, and an inner loop for task parallelism. This nested loop approach provides a systematic way to explore all possible configurations of combining multiple parallelisms (e.g., pipeline parallelism, data parallelism, and task parallelism) for distributing an AI workload across a cluster of devices.

Specifically, the search begins by iterating over possible numbers of pipeline stages (pipeline parallelism), determined by the divisors of num_blocks. Then, it calculates the number of devices per stage by dividing num_total_devices by the number of stages. For example, if the number of blocks is 16 and the total number of devices in the device cluster is 32, then the possible number of stages can be 1, 2, 4, 8, or 16 (with 16, 8, 4, 2, or 1 block per stage), and the number of devices per stage can be 32, 16, 8, 4, and 2, respectively.

The function 1900 proceeds with two intermediate loops for cell-level data parallelism. The first intermediate loop iterates over each cell within the block. For each cell, the second intermediate loop determines possible numbers of cell replicas, which are determined by the divisors of the number of devices per stage. The devices per stage are then evenly partitioned among these cell replicas. For example, if the block has two cells, and the number of devices per stage is 4, then each cell can have one cell replica to which all four devices are assigned, or two cell replicas each of which is partitioned with two devices, or four cell replicas each of which is partitioned with have one device.

Next, the function 1900 enters the inner loop where a task mapping is generated for each cell replica. The task mapping maps the set of tasks included in the cell to the devices partitioned into the cell replica, using a registered parallel template associated with the cell, as described above.

In this example, only cell-level data parallelism is considered. In other examples, another dimension for model-level data parallelism can also be considered by adding another loop over all possible numbers of model replicas outside the loop for pipeline parallelism, (e.g., by performing step 422 ahead of step 424 in FIG. 4). In such scenarios, the total number of devices in the device cluster can be evenly partitioned into multiple model replicas (e.g., if the number of model replicas is a divisor of the total number of devices in the device cluster). For example, if there are a total of 8 devices in the device cluster, the number of model replicas can be 1 (which is assigned all 8 devices), 2 (each is assigned 4 devices), 4 (each is assigned 2 devices), and 8 (each is assigned one device). Then, devices partitioned into each model replica can be evenly partitioned into the number of stages (e.g., if the number of stages is a divisor of the count of devices partitioned into each model replica). In other words, instead of dividing the total number of devices in the device cluster by the number of stages, the pipeline parallelism divides the total number of devices partitioned into each model replica by the number of stages.

In some examples, some of the generated parallel schedules can be “pruned” before evaluating their performance, that is, simulation for estimation of resource usage (as described further below) can be skipped for those configurations which are obviously infeasible given hardware limitations. Such pruning can be performed, e.g., by comparing a parameter size of the transformer model and a memory capacity of the devices in the device cluster. For instance, if attempting to deploy a transformer model with 30 billion parameters onto two A100-40GB GPUs, a parallel schedule having two pipeline stages—where each stage would require managing 15 billion parameters equivalent to 30 GB per GPU—would be pruned as they exceed the available memory capacity. Conversely, a parallel schedule like one pipeline stage handling all 30 billion parameters or 60 GB would be considered feasible, thus not pruned from further evaluation. Pruning can eliminate the obviously infeasible parallel schedules early in the process, thereby saving computational resources and time for subsequent resource usage estimation of the parallel schedules.

### Example Simulation and Resource Usage Estimation

For each candidate execution plan represented by a parallel schedule, a simulation can be performed (e.g., via the simulator 160 of FIG. 1) to estimate a resource usage of the candidate execution plan, such as the total processing time for using the parallel schedule to process all input requests specified in the workload. During the simulation, if there are more than one model replicas, the disclosed automatic partition framework can assume the requests are evenly distributed to the model replicas. The framework can also make the same assumption for cell replicas.

In some examples, the disclosed automatic partition framework is configured to simulate dynamic batching to handle variable workloads and maximize hardware utilization. Dynamic matching aggregates incoming requests into batches in real-time, rather than waiting for fixed batch size or time interval.

In some examples, the disclosed automatic partition framework can be configured to use a greedy algorithm to batch a subset of the input requests based on available memory capacity of the devices in the device cluster. The framework can be configured to continuously monitor the progress of each request and adjusts the key-value (KV) cache size in real-time. In transformer models, the KV cache is typically used to store intermediate token states during the processing of sequential data, which helps in reusing computations from previous tokens and making the process more efficient. The KV cache can limit the maximum number of requests that can be batched together for an iteration. For instance, if the KV cache can hold 1000 token states and each request generates 200 token states, the maximum number of requests that can be batched together would be 5. Thus, during each iteration, the disclosed automatic partition framework can evaluate the KV cache size to determine if it can accept a new token into the current in-flight batch. This ensures that the batch size is maximized without exceeding the cache limits. For example, in an ongoing batch with 4 requests, if the current KV cache usage is 800 token states, and a new request arrives, the framework checks the remaining KV cache capacity. If the new request requires 150 token states, it is accepted into the batch. If the new request requires 250 token states, it is deferred to the next batch. This continuous monitoring and adjustment of the KV cache size allow the framework to efficiently manage the in-flight batch and ensure optimal utilization of the available device memory.

In some examples, the total processing time can be estimated to be the sum of estimated total operation time spent by all cells in the transformer model and total operation time spent by collective communications between the cells in the transformer model. The former represents time spent on performing various tasks of the transformer model, whereas the latter represents time spent on exchanging data and synchronizing operations between the cells in the transformer model (or overhead).

In some examples, estimation of the processing time can be performed by linearly interpolating operation times of one or more operations performed by the cells or collective communications based on some predetermined operation-level benchmarks.

Linear interpolation involves using known data points (i.e., benchmarks) to estimate the value at an unknown point. For instance, if the execution times for matrix multiplications of shapes 256×256 and 512×512 are known, and a new operation requires multiplying matrices of shape 300×300, the execution time can be estimated by linearly interpolating between the known times. The same principle applies to other operations performed by the cells such as attention operation with different batch sizes and sequence lengths, and attention operation with KV cache with different sequence lengths.

Similarly, linear interpolation can be used to estimate time spent by collective communications such as all reduce, all gather, reduce scatter, and all to all. For example, the simulator 160 can receive benchmarks for these operations with different numbers of nodes and devices per node. If a new configuration arises, such as a different number of nodes or devices per node, the simulator 160 can use linear interpolation to estimate the corresponding overhead. For example, if the time for all-reduce across 4 nodes is known, and a new operation involves 6 nodes, the simulator 160 can estimate the time for all-reduce across the 6 nodes by interpolating from the known benchmarks.

### Example Simulation Results

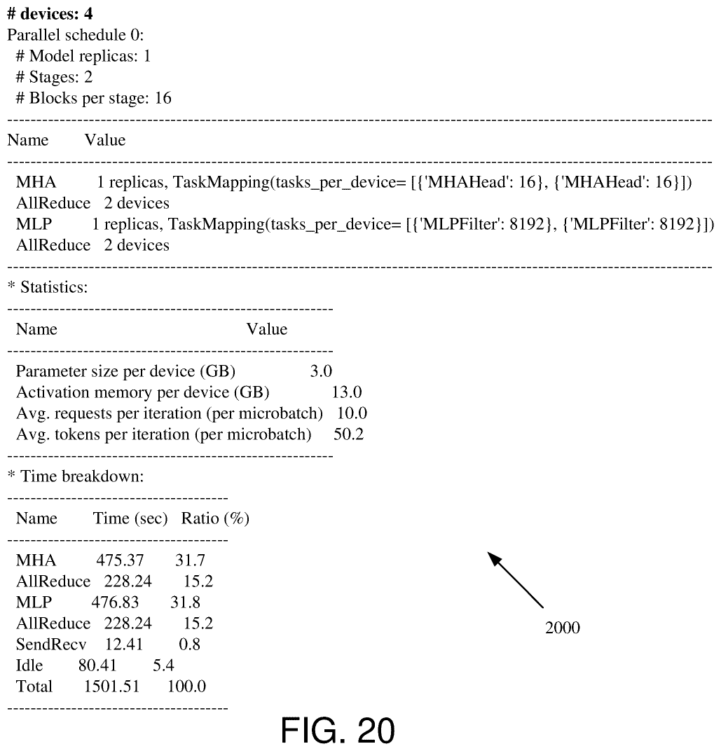

For each candidate execution plan, the simulation results can include estimated resource usage and runtime statistics. FIG. 20 depicts example simulation results 2000 of an optimal parallel schedule obtained in one experiment. In this experiment, the transformer model is facebook/OPT-6.7B (available from Hugging Face), the device cluster has one node including 4 devices (GPUs), the prompt length is 4096, and the output length is 1024.

Among all possible parallel schedules found by the disclosed automatic partition framework, parallel schedule 0 is found to have the lowest resource usage or total processing time.

Specifically, this optimal parallel schedule determines that the number of model replica is 1, the number of stages is 2 and there are 16 blocks in each stage. Thus, each stage will be assigned 2 devices. Each block includes an MHA cell and an MLP cell. The MHA cell has one cell replica; thus, the tasks of MHA are mapped to the two devices, each having 16 attention heads. The outputs of the MHA cell are synchronized by all-reduce operation which sums the outputs of the two devices. Similarly, the MLP cell has one cell replica; thus, the filters of MLP are mapped to the two devices, each having a filter with 8192 parameters. The outputs of these two devices are all-reduced for subsequent operations. The simulation results 2000 also shows runtime statistics such as parameter size per device, activation memory per device, average requests per iteration (per micro-batch), average tokens per iteration (per micro-batch), etc. Additionally, simulation results 2000 can breakdown the total processing time to time spent on MHA cell, all-reduce operation after the MHA cell, MLP cell, all-reduce operation after the MLP cell, send and receive operations between two stages, and system idle time. For instance, in the depicted example, about 31.7% and 31.8% of the total processing time are spent on the MHA cell and MLP cell, respectively, and about 15.2% of the total processing time is spent on each of the two all-reduce operations.

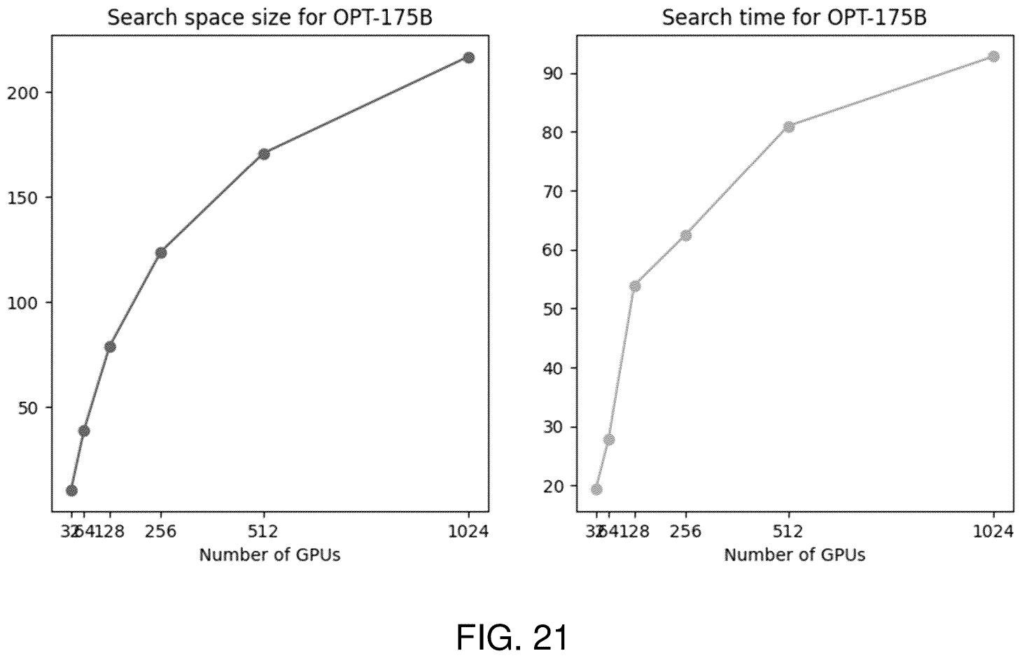

FIG. 21 shows example experimental results of search space size and search time for a transformer model OPT-175B. In this experiment, a 12-core Intel i7-1265U CPU is used, and the workload defines both the prompt length and the output lengths to be 1024. The vertical axis of the left panel represents the size of search space, which can be defined by the number of candidate execution plans (or the number of parallel schedules) found by the search engine of the disclosed automatic partition framework, and the vertical axis of the right panel shows the total search time. In both graphs, the horizontal axis represents the number of devices (GPUs) in the device cluster. As shown, the size of the search space increases as the number of devices in the device cluster increases as more partitioning options are available. However, it is important to note that the increase in the size of the search space is not exponential, but rather, it gradually plateaus. Similarly, the total search time also shows a trend of gradual plateauing, indicating an efficient search algorithm of the disclosed automatic partition framework that manages to keep the search time under control despite the growing search space.

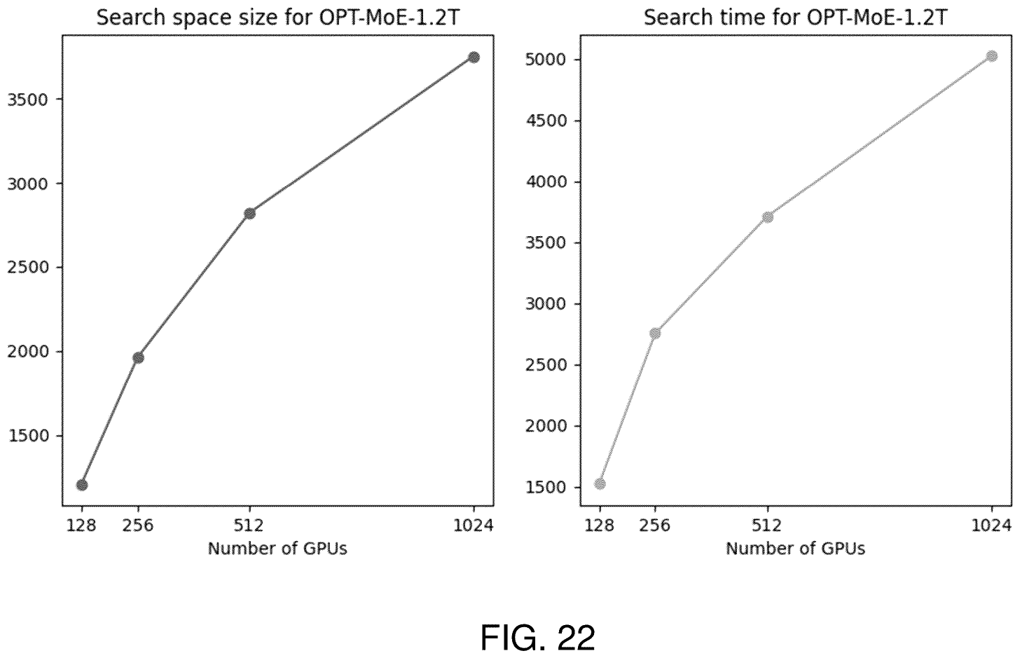

FIG. 22 shows example experimental results of search space size and search time for another transformer model OPT-MoE-1.2T, which is OPT-66B plus an MoE cell including 64 experts. Similar to FIG. 21, FIG. 22 also shows increasing size of the search space and search time as the number of devices in the device cluster increases and such increase gradually plateaus. FIG. 22 also shows that both the search space and search time for the OPT-MoE-1.2T model are significantly larger than those of the OPT-175B model. This could be explained by the fact that a block in the OPT-MoE-1.2T model has four cells, whereas a block in the OPT-175B model has two cells. Generally, the search space size (and the search time) exponentially grows as the number of cells in a block increases.

### Example Advantages

The disclosed technologies present several technical advantages in the rapidly evolving field of generative AI, particularly in managing the computational demands of large transformer models.

First, the disclosed technologies introduce a novel automatic partition framework which can automatically generate a large set of candidate execution plans for the parallel execution of a transformer model on a device cluster. This is in contrast to conventional heuristic approaches, which rely on some predefined rules and may not explore the full range of possible execution plans. This framework can evaluate the resource usage of each candidate execution plan for processing a workload through simulation and select an optimal execution plan that has the lowest resource usage. This simulation-based approach ensures a more exhaustive search for the optimal execution plan among many candidate execution plans. The identified optimal execution plan can save substantial computing resources and time during the execution of the transformer model. Importantly, the disclosed automatic partition framework is designed to consider the dynamism inherent in generative AI inference, such as dynamic sequence lengths and dynamic batching, thereby maximizing the throughput of the model.

Moreover, the disclosed technologies can generate a parallel schedule that incorporates mixed types of parallelism, specifically combining pipeline parallelism, data parallelism, and task parallelism, for partitioning devices included in a device cluster for parallel execution of a transformer model. Each form of parallelism has its own strengths and is more suitable for specific types of workloads. By integrating these different forms of parallelism into the parallel schedule, the disclosed technologies offer a more comprehensive and flexible approach to partitioning devices in a device cluster. This approach can lead to significant savings in computing resources and time during the execution of the transformer model, while also accommodating the dynamic nature of generative AI inference.

Further, the disclosed technologies employ a nested loop approach to searching for parallel schedules for partitioning devices included in a device cluster for parallel execution of a transformer model. This approach provides a more efficient and comprehensive way for exploring parallel schedules, while simultaneously constraining the search space, despite the increasing size of the transformer model. This results in a more scalable solution compared to conventional approaches which often face challenges due to the exponential increase in complexity with the growth of the model size. Uniquely, by capitalizing on the repeated layer structure inherent in the transformer model, the disclosed technologies ensure that the search time does not escalate exponentially with the increase in layers, thereby conserving substantial computing resources and time during the enumeration of potential parallel schedules.

### Example Computing Systems

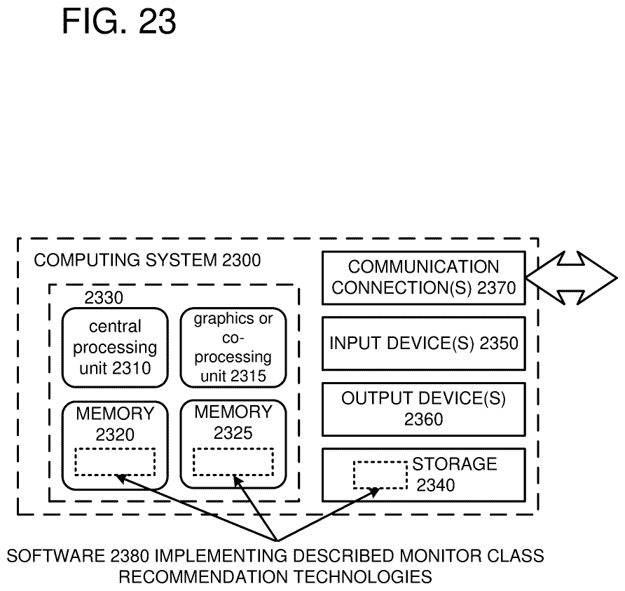

FIG. 23 depicts an example of a suitable computing system 2300 in which the described innovations can be implemented. The computing system 2300 is not intended to suggest any limitation as to scope of use or functionality of the present disclosure, as the innovations can be implemented in diverse computing systems.

With reference to FIG. 23, the computing system 2300 includes one or more processing units 2310, 2315 and memory 2320, 2325. In FIG. 23, this basic configuration 2330 is included within a dashed line. The processing units 2310, 2315 can execute computer-executable instructions, such as for implementing the features described in the examples herein (e.g., the methods 200, 300, 400). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 23 shows a central processing unit 2310 as well as a graphics processing unit or co-processing unit 2315. The tangible memory 2320, 2325 can be volatile memory (e.g., registers, cache, RAM), non-volatile memory (e.g., ROM, EEPROM, flash memory, etc.), or some combination of the two, accessible by the processing unit(s) 2310, 2315. The memory 2320, 2325 can store software 2380 implementing one or more innovations described herein, in the form of computer-executable instructions suitable for execution by the processing unit(s) 2310, 2315.

More generally, the term “processor” refers generically to any device that can process computer-executable instructions and may include a microprocessor, microcontroller, programmable logic device, digital signal processor, and/or other computational device. A processor may be a processing core of a CPU, other general-purpose unit, or GPU. A processor may also be a specific-purpose processor implemented using, for example, an ASIC or a field-programmable gate array (“FPGA”). A “processor system” is a set of one or more processors, which can be located together or distributed across a network.

A computing system 2300 can have additional features. For example, the computing system 2300 can include storage 2340, one or more input devices 2350, one or more output devices 2360, and one or more communication connections 2370, including input devices, output devices, and communication connections for interacting with a user. An interconnection mechanism (not shown) such as a bus, controller, or network can interconnect the components of the computing system 2300. Typically, operating system software (not shown) can provide an operating environment for other software executing in the computing system 2300, and coordinate activities of the components of the computing system 2300.

The tangible storage 2340 can be removable or non-removable, and includes magnetic disks, magnetic tapes or cassettes, CD-ROMs, DVDs, or any other medium which can be used to store information in a non-transitory way and which can be accessed within the computing system 2300. The storage 2340 can store instructions for the software implementing one or more innovations described herein.

The input device(s) 2350 can be an input device such as a keyboard, mouse, pen, or trackball, a voice input device, a scanning device, touch device (e.g., touchpad, display, or the like) or another device that provides input to the computing system 2300. The output device(s) 2360 can be a display, printer, speaker, CD-writer, or another device that provides output from the computing system 2300.

The communication connection(s) 2370 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Computer-readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

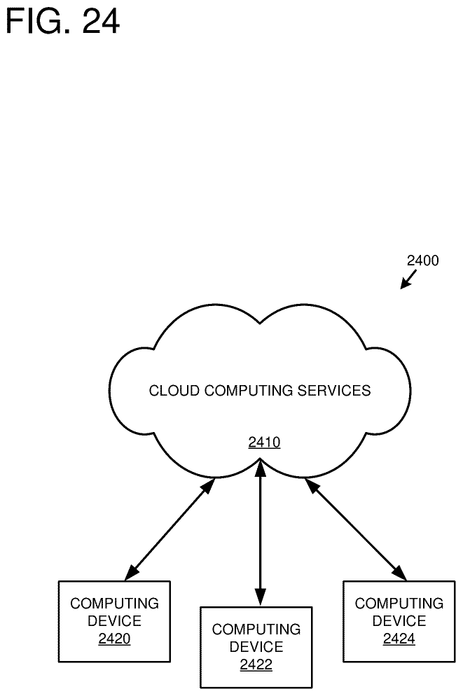

FIG. 24 depicts an example cloud computing environment 2400 in which the described technologies can be implemented, including, e.g., the system 100 and other systems herein. The cloud computing environment 2400 can include cloud computing services 2410. The cloud computing services 2410 can comprise various types of cloud computing resources, such as computer servers, data storage repositories, networking resources, etc. The cloud computing services 2410 can be centrally located (e.g., provided by a facility of a business or organization) or distributed (e.g., provided by various computing resources located at different locations, such as different facilities and/or located in different cities or countries).

The cloud computing services 2410 can be utilized by various types of computing devices (e.g., client computing devices), such as computing devices 2420, 2422, and 2424.

For example, the computing devices (e.g., 2420, 2422, and 2424) can be computers (e.g., desktop or laptop computers), mobile devices (e.g., tablet computers or smart phones), or other types of computing devices. For example, the computing devices (e.g., 2420, 2422, and 2424) can utilize the cloud computing services 2410 to perform computing operations (e.g., data processing, data storage, and the like).

In practice, cloud-based, on-premises-based, or hybrid scenarios can be supported.

### Example Implementations

In any of the examples herein, a software application (or “application”) can take the form of a single application or a suite of a plurality of applications, whether offered as a service (SaaS), in the cloud, on premises, on a desktop, mobile device, wearable, or the like.

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises. ” Further, “and/or” means “and” or “or,” as well as “and” and “or.”

In any of the examples described herein, an operation performed in runtime means that the operation can be completed in real time or with negligible processing latency (e.g., the operation can be completed within 1 second, etc.).

### EXAMPLE CLAUSES

Any of the following example clauses can be implemented.

Clause A1. A computing system, comprising: memory; a processor system coupled to the memory; and one or more computer readable storage media storing instructions that, when loaded into the memory, cause the processor system to perform operations comprising: receiving an internal representation of a transformer model, an internal representation of a device cluster, and an internal representation of a workload for execution of the transformer model on the device cluster; generating a plurality of candidate execution plans based on the internal representation of the transformer model and the internal representation of the device cluster, wherein each candidate execution plan represents a unique parallel schedule for partitioning devices in the device cluster for parallel execution of the transformer model; and determining an optimal execution plan, comprising: evaluating resource usage of the plurality of candidate execution plans based on the internal representation of the workload, wherein the evaluating comprises simulating execution of the transformer model on the device cluster to process the workload; and selecting, among the plurality of candidate execution plans, the optimal execution plan which yields the lowest resource usage.

Clause A2. The computing system of clause A1, wherein the internal representation of the transformer model defines one or more repeating blocks, wherein each block defines a sequence of cells, wherein each cell includes a set of tasks defined by the transformer model.

Clause A3. The computing system of clause A2, wherein the set of tasks in a cell is configured to implement a specific neural network.

Clause A4. The computing system of any one of clauses A2-A3, wherein the generating the plurality of candidate execution plans comprises enumerating different combinations of a pipeline parallelism, a data parallelism, and a task parallelism, wherein the pipeline parallelism partitions the one or more repeating blocks into one or more pipeline stages, the data parallelism creates one or more replicas of the transformer model or some of the cells, and the task parallelism maps the set of tasks included in a selected cell to one or more devices of the device cluster.

Clause A5. The computing system of any one of clauses A2-A4, wherein the evaluating resource usage of a selected candidate execution plan comprises estimating a processing time for the selected candidate execution plan to process all input requests in the workload.

Clause A6. The computing system of clause A5, wherein the simulating comprises dynamically batching a subset of the input requests based on available memory capacity of the devices in the device cluster.

Clause A7. The computing system of any one of clauses A5-A6, wherein the estimating the processing time comprises estimating total operation time spent by the cells in the transformer model and total operation time spent by collective communications between the cells in the transformer model.

Clause A8. The computing system of clause A7, wherein the estimating the processing time comprises linearly interpolating operation times of one or more operations performed by the cells or collective communications based on some predetermined operation-level benchmarks.

Clause A9. The computing system of any one of clauses A1-A8, wherein the internal representation of the workload defines an input size, an output size, and a number of prompts, wherein the input size defines a number of tokens in a prompt provided as an input to the transformer model, wherein the output size defines a number of tokens generated as an output of the transformer model in response to a prompt.

Clause A10. The computing system of any one of clauses A1-A9, wherein the internal representation of the device cluster defines a plurality of nodes interconnected to one another, wherein each node includes one or more devices.

Clause A11. A computer-implemented method, comprising: receiving an internal representation of a transformer model, an internal representation of a device cluster, and an internal representation of a workload for execution of the transformer model on the device cluster; generating a plurality of candidate execution plans based on the internal representation of the transformer model and the internal representation of the device cluster, wherein each candidate execution plan represents a unique parallel schedule for partitioning devices in the device cluster for parallel execution of the transformer model; and determining an optimal execution plan, comprising: evaluating resource usage of the plurality of candidate execution plans based on the internal representation of the workload, wherein the evaluating comprises simulating execution of the transformer model on the device cluster to process the workload; and selecting, among the plurality of candidate execution plans, the optimal execution plan which yields the lowest resource usage.

Clause A12. The method of clause A11, wherein the internal representation of the transformer model defines one or more repeating blocks, wherein each block defines a sequence of cells, wherein each cell includes a set of tasks defined by the transformer model.

Clause A13. The method of clause A12, wherein the generating the plurality of candidate execution plans comprises enumerating different combinations of a pipeline parallelism, a data parallelism, and a task parallelism, wherein the pipeline parallelism partitions the one or more repeating blocks into one or more pipeline stages, the data parallelism creates one or more replicas of the transformer model or some of the cells, and the task parallelism maps the set of tasks included in a selected cell to one or more devices of the device cluster.

Clause A14. The method of any one of clauses A12-A13, wherein the evaluating resource usage of a selected candidate execution plan comprises estimating a processing time for the selected candidate execution plan to process all input requests in the workload.

Clause A15. The method of clause A14, wherein the simulating comprises dynamically batching a subset of the input requests based on available memory capacity of the devices in the device cluster.

Clause A16. The method of any one of clauses A14-A15, wherein the estimating the processing time comprises estimating total operation time spent by the cells in the transformer model and total operation time spent by collective communications between the cells in the transformer model.

Clause A17. The method of clause A16, wherein the estimating the processing time comprises linearly interpolating operation times of one or more operations performed by the cells or collective communications based on some predetermined operation-level benchmarks.

Clause A18. The method of any one of clauses A11-A17, wherein the internal representation of the workload defines an input size, an output size, and a number of prompts, wherein the input size defines a number of tokens in a prompt provided as an input to the transformer model, wherein the output size defines a number of tokens generated as an output of the transformer model in response to a prompt.

Clause A19. The method of any one of clauses A11-A18, wherein the internal representation of the device cluster defines a plurality of nodes interconnected to one another, wherein each node includes one or more devices.

Clause A20. One or more computer-readable media having encoded thereon computer-executable instructions causing one or more processors to perform a method, the method comprising: receiving an internal representation of a transformer model, an internal representation of a device cluster, and an internal representation of a workload for execution of the transformer model on the device cluster; generating a plurality of candidate execution plans based on the internal representation of the transformer model and the internal representation of the device cluster, wherein each candidate execution plan represents a unique parallel schedule for partitioning devices in the device cluster for parallel execution of the transformer model; and determining an optimal execution plan, comprising: evaluating resource usage of the plurality of candidate execution plans based on the internal representation of the workload, wherein the evaluating comprises simulating execution of the transformer model on the device cluster to process the workload; and selecting, among the plurality of candidate execution plans, the optimal execution plan which yields the lowest resource usage.

Clause B1. A computer-implemented method, comprising: generating a parallel schedule for partitioning devices included in a device cluster for parallel execution of a transformer model, wherein the transformer model is represented by a chain of cells, each cell including a set of tasks of the transformer model, and wherein the generating the parallel schedule comprises: dividing the chain of cells into one or more sequential stages; creating one or more replicas of the transformer model or some of the cells; and mapping the set of tasks included in a cell to one or more devices of the device cluster; and for a given workload, executing the transformer model on the device cluster according to the parallel schedule.

Clause B2. The method of clause B1, further comprising pruning the plurality of parallel schedules before estimating the processing times, wherein the pruning comprises comparing a parameter size of the transformer model and a memory capacity of the devices in the device cluster.

Clause B3. The method of any one of clauses B1-B2, wherein the generating the plurality of parallel schedules comprises applying resharding operations to a selected parallel schedule which has two adjacent cells that have different numbers of cell replicas.

Clause B4. The method of clause B3, wherein the two adjacent cells include an upstream cell having A cell replicas and a downstream cell having B cell replicas, wherein A is a multiple of B, wherein the resharding operations are all-gather operations which collect outputs of the A cell replicas of the upstream cell for distribution among the B cell replicas of the downstream cell.

Clause B5. The method of clause B3, wherein the two adjacent cells include an upstream cell having A cell replicas and a downstream cell having B cell replicas, wherein B is a multiple of A, wherein the resharding operations are gating operations which discard at least some outputs of the A cell replicas of the upstream cell and distribute remaining outputs of the A cell replicas of the upstream cell to the B cell replicas of the downstream cell.

Clause B6. The method of any one of clauses B1-B5, wherein the chain of cells includes at least one of a multi-head attention (MHA) cell type configured to implement an MHA neural network, a multi-layer perception (MLP) cell type configured to implement an MLP neural network, a gated linear unit (GLU) cell type configured to implement a GLU filter, a mixture of experts (MoE) cell type configured to implement a MoE neural network layer, and a parallel MHA and MLP cell type configured to implement a parallel MHA and MLP neural network.

Clause B7. The method of clause B6, further comprising registering a plurality of parallel templates corresponding to different cell types, wherein each parallel template defines a task mapping scheme for dividing tasks of a cell having the corresponding cell type among a given number of devices in the device cluster and a corresponding type of collective communications for synchronizing outputs of the tasks divided among the given number of devices.

Clause B8. The method of clause B7, wherein the plurality of parallel templates includes a first parallel template defining a first task mapping scheme for a specific cell type, wherein the first task mapping scheme evenly or substantially evenly divides tasks of a cell having the specific cell type among the given number of devices in the device cluster.

Clause B9. The method of any one of clauses B7-B8, wherein the plurality of parallel templates includes a second parallel template defining a second task mapping scheme for the MoE cell type, wherein the second task mapping scheme maps multiple experts of a cell having the MoE cell type to the given number of devices in the device cluster so that each device has equal or substantially equal number of experts.

Clause B10. The method of any one of clauses B7-B8, wherein the plurality of parallel templates includes a third parallel template defining a third task mapping scheme for the MoE cell type, wherein the third task mapping scheme assigns filters of each expert of a cell having the MoE cell type to the given number of devices in the device cluster so that each device is assigned equal or substantially equal number of filters of all experts.

Clause B11. A computing system, comprising: memory; a processor system coupled to the memory; and one or more computer readable storage media storing instructions that, when loaded into the memory, cause the processor system to perform operations comprising: generating a parallel schedule for partitioning devices included in a device cluster for parallel execution of a transformer model, wherein the transformer model is represented by a chain of cells, each cell including a set of tasks of the transformer model, and wherein the generating the parallel schedule comprises: dividing the chain of cells into one or more sequential stages; creating one or more replicas of the transformer model or some of the cells; and mapping the set of tasks included in a cell to one or more devices of the device cluster; and for a given workload, executing the transformer model on the device cluster according to the parallel schedule.

Clause B12. The computing system of clause B11, wherein the operations further comprise pruning the plurality of parallel schedules before estimating the processing times, wherein the pruning comprises comparing a parameter size of the transformer model and a memory capacity of the devices in the device cluster.

Clause B13. The computing system of any one of clauses B11-B12, wherein the generating the plurality of parallel schedules comprises applying resharding operations to a selected parallel schedule which has two adjacent cells that have different numbers of cell replicas.

Clause B14. The computing system of clause B13, wherein the two adjacent cells include an upstream cell having A cell replicas and a downstream cell having B cell replicas, wherein A is a multiple of B, wherein the resharding operations are all-gather operations which collect outputs of the A cell replicas of the upstream cell for distribution among the B cell replicas of the downstream cell.

Clause B15. The computing system of clause B13, wherein the two adjacent cells include an upstream cell having A cell replicas and a downstream cell having B cell replicas, wherein B is a multiple of A, wherein the resharding operations are gating operations which discard at least some outputs of the A cell replicas of the upstream cell and distribute remaining outputs of the A cell replicas of the upstream cell to the B cell replicas of the downstream cell.

Clause B16. The computing system of any one of clauses B11-B15, wherein the chain of cells has different cell types, wherein the operations further comprise registering a plurality of parallel templates corresponding to the different cell types, wherein each parallel template defines a task mapping scheme for dividing tasks of a cell having the corresponding cell type among a given number of devices in the device cluster and a corresponding type of collective communications for synchronizing outputs of the tasks divided among the given number of devices.

Clause B17. The computing system of clause B16, wherein the plurality of parallel templates includes a first parallel template defining a first task mapping scheme for a specific cell type, wherein the first task mapping scheme evenly or substantially evenly divides tasks of a cell having the specific cell type among the given number of devices in the device cluster.

Clause B18. The computing system of any one of clauses B16-B17, wherein the plurality of parallel templates includes a second parallel template defining a second task mapping scheme for the MoE cell type, wherein the second task mapping scheme maps multiple experts of a cell having the MoE cell type to the given number of devices in the device cluster so that each device has equal or substantially equal number of experts.

Clause B19. The computing system of any one of clauses B16-B17, wherein the plurality of parallel templates includes a third parallel template defining a third task mapping scheme for the MoE cell type, wherein the third task mapping scheme assigns filters of each expert of a cell having the MoE cell type to the given number of devices in the device cluster so that each device is assigned equal or substantially equal number of filters of all experts.

Clause B20. One or more computer-readable media having encoded thereon computer-executable instructions causing one or more processors to perform a method, the method comprising: generating a parallel schedule for partitioning devices included in a device cluster for parallel execution of a transformer model, wherein the transformer model is represented by a chain of cells, each cell including a set of tasks of the transformer model, and wherein the generating the parallel schedule comprises: dividing the chain of cells into one or more sequential stages; creating one or more replicas of the transformer model or some of the cells; and mapping the set of tasks included in a cell to one or more devices of the device cluster; and for a given workload, executing the transformer model on the device cluster according to the parallel schedule.

Clause C1. A computer-implemented method, comprising: receiving an internal representation of a transformer model, wherein the internal representation defines one or more repeating blocks, each block comprising a sequence of cells, and each cell comprising a set of tasks of the transformer model; and searching for a plurality of parallel schedules for partitioning devices included in a device cluster for parallel execution of the transformer model, wherein the searching comprises: determining a number of model replicas, wherein each model replica represents a copy of the transformer model, wherein devices included in the device cluster are partitioned into the number of model replicas; determining a number of stages that divide the one or more repeating blocks, wherein devices partitioned into each model replica are partitioned into the number of stages; determining a number of cell replicas for each cell in a block, wherein each cell replica represents a copy of the corresponding cell, wherein devices partitioned into each stage are partitioned into the number of cell replicas; and for each cell replica of a cell, generating a task mapping which maps the set of tasks included in the cell to devices partitioned into the cell replica.

Clause C2. The method of clause C1, wherein the number of model replicas is a divisor of a count of devices included in the device cluster, wherein devices included in the device cluster are evenly partitioned into the number of model replicas.

Clause C3. The method of any one of clauses C1-C2, wherein the number of stages is a divisor of a count of devices partitioned into each model replica, wherein devices partitioned into each model replica are evenly partitioned into the number of stages.

Clause C4. The method of any one of clauses C1-C3, wherein the number of cell replicas is a divisor of a count of devices partitioned into each stage, wherein devices partitioned into each stage are evenly partitioned into the number of cell replicas.

Clause C5. The method of any one of clauses C1-C4, wherein the generating the task mapping comprises dividing the set of tasks included in the cell evenly or substantially evenly among devices partitioned into the cell replica.

Clause C6. The method of clause C5, wherein the generating the task mapping further comprises determining a type of collective communications specific to the cell to synchronize outputs of the set of tasks that are divided among devices partitioned into the cell replica.

Clause C7. The method of clause C6, wherein the type of collective communications comprises all-gather, all-reduce, reduce-scatter, or all-to-all.

Clause C8. The method of any one of clauses C1-C7, wherein each block has two adjacent cells that have different numbers of cell replicas, the method further comprising determining resharding operations between the two adjacent cells.

Clause C9. The method of any one of clauses C1-C8, further comprising selecting, among the plurality of parallel schedules, an optimal parallel schedule whose estimated processing time is the lowest for executing the transformer model on the device cluster to process a workload.

Clause C10. The method of clause C9, wherein the selecting comprises simulating execution of the transformer model on the device cluster to process the workload using each one of the plurality of parallel schedules.

Clause C11. A computing system, comprising: memory; a processor system coupled to the memory; and one or more computer readable storage media storing instructions that, when loaded into the memory, cause the processor system to perform operations comprising: receiving an internal representation of a transformer model, wherein the internal representation defines one or more repeating blocks, each block comprising a sequence of cells, and each cell comprising a set of tasks of the transformer model; and searching for a plurality of parallel schedules for partitioning devices included in a device cluster for parallel execution of the transformer model, wherein the searching comprises: determining a number of model replicas, wherein each model replica represents a copy of the transformer model, wherein devices included in the device cluster are partitioned into the number of model replicas; determining a number of stages that divide the one or more repeating blocks, wherein devices partitioned into each model replica are partitioned into the number of stages; determining a number of cell replicas for each cell in a block, wherein each cell replica represents a copy of the corresponding cell, wherein devices partitioned into each stage are partitioned into the number of cell replicas; and for each cell replica of a cell, generating a task mapping which maps the set of tasks included in the cell to devices partitioned into the cell replica.

Clause C12. The computing system of clause C11, wherein the number of model replicas is a divisor of a count of repeating blocks, wherein devices included in the device cluster are evenly partitioned into the number of model replicas.

Clause C13. The computing system of any one of clauses C11-C12, wherein the number of stages is a divisor of a count of devices partitioned into each model replica, wherein devices partitioned into each model replica are evenly partitioned into the number of stages.

Clause C14. The computing system of any one of clauses C11-C13, wherein the number of cell replicas is a divisor of a count of devices partitioned into each stage, wherein devices partitioned into each stage are evenly partitioned into the number of cell replicas.

Clause C15. The computing system of any one of clauses C11-C14, wherein the generating the task mapping comprises dividing the set of tasks included in the cell evenly or substantially evenly among devices partitioned into the cell replica.

Clause C16. The computing system of clause C15, wherein the generating the task mapping further comprises determining a type of collective communications specific to the cell to combine outputs of the set of tasks that are divided among devices partitioned into the cell replica.

Clause C17. The computing system of any one of clauses C11-C16, wherein each block has two adjacent cells that have different numbers of cell replicas, the method further comprising determining resharding operations between the two adjacent cells.

Clause C18. The computing system of any one of clauses C11-C17, further comprising selecting, among the plurality of parallel schedules, an optimal parallel schedule whose estimated processing time is the lowest for executing the transformer model on the device cluster to process a workload.

Clause C19. The computing system of clause C18, wherein the selecting comprises simulating execution of the transformer model on the device cluster to process the workload using each one of the plurality of parallel schedules.

Clause C20. One or more computer-readable media having encoded thereon computer-executable instructions causing one or more processors to perform a method, the method comprising: receiving an internal representation of a transformer model, wherein the internal representation defines one or more repeating blocks, each block comprising a sequence of cells, and each cell comprising a set of tasks of the transformer model; and searching for a plurality of parallel schedules for partitioning devices included in a device cluster for parallel execution of the transformer model, wherein the searching comprises: determining a number of model replicas, wherein each model replica represents a copy of the transformer model, wherein devices included in the device cluster are partitioned into the number of model replicas; determining a number of stages that divide the one or more repeating blocks, wherein devices partitioned into each model replica are partitioned into the number of stages; determining a number of cell replicas for each cell in a block, wherein each cell replica represents a copy of the corresponding cell, wherein devices partitioned into each stage are partitioned into the number of cell replicas; and for each cell replica of a cell, generating a task mapping which maps the set of tasks included in the cell to devices partitioned into the cell replica.

### EXAMPLE ALTERNATIVES

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method, comprising:
receiving an internal representation of a transformer model, wherein the internal representation defines one or more repeating blocks, each block comprising a sequence of cells, and each cell comprising a set of tasks of the transformer model; and
searching for a plurality of parallel schedules for partitioning devices included in a device cluster for parallel execution of the transformer model, wherein the searching comprises:
determining a number of model replicas, wherein each model replica represents a copy of the transformer model, wherein devices included in the device cluster are partitioned into the number of model replicas;
determining a number of stages that divide the one or more repeating blocks, wherein devices partitioned into each model replica are partitioned into the number of stages;
determining a number of cell replicas for each cell in a block, wherein each cell replica represents a copy of the corresponding cell, wherein devices partitioned into each stage are partitioned into the number of cell replicas; and
for each cell replica of a cell, generating a task mapping which maps the set of tasks included in the cell to devices partitioned into the cell replica.

2. The method of claim 1, wherein the number of model replicas is a divisor of a count of devices included in the device cluster, wherein devices included in the device cluster are evenly partitioned into the number of model replicas.

3. The method of claim 1, wherein the number of stages is a divisor of a count of devices partitioned into each model replica, wherein devices partitioned into each model replica are evenly partitioned into the number of stages.

4. The method of claim 1, wherein the number of cell replicas is a divisor of a count of devices partitioned into each stage, wherein devices partitioned into each stage are evenly partitioned into the number of cell replicas.

5. The method of claim 1, wherein the generating the task mapping comprises dividing the set of tasks included in the cell evenly or substantially evenly among devices partitioned into the cell replica.

6. The method of claim 5, wherein the generating the task mapping further comprises determining a type of collective communications specific to the cell to synchronize outputs of the set of tasks that are divided among devices partitioned into the cell replica.

7. The method of claim 6, wherein the type of collective communications comprises all-gather, all-reduce, reduce-scatter, or all-to-all.

8. The method of claim 1, wherein each block has two adjacent cells that have different numbers of cell replicas, the method further comprising determining resharding operations between the two adjacent cells.

9. The method of claim 1, further comprising selecting, among the plurality of parallel schedules, an optimal parallel schedule whose estimated processing time is the lowest for executing the transformer model on the device cluster to process a workload.

10. The method of claim 9, wherein the selecting comprises simulating execution of the transformer model on the device cluster to process the workload using each one of the plurality of parallel schedules.

11. A computing system, comprising:
memory;
a processor system coupled to the memory; and
one or more computer readable storage media storing instructions that, when loaded into the memory, cause the processor system to perform operations comprising:
receiving an internal representation of a transformer model, wherein the internal representation defines one or more repeating blocks, each block comprising a sequence of cells, and each cell comprising a set of tasks of the transformer model; and
searching for a plurality of parallel schedules for partitioning devices included in a device cluster for parallel execution of the transformer model, wherein the searching comprises:
determining a number of model replicas, wherein each model replica represents a copy of the transformer model, wherein devices included in the device cluster are partitioned into the number of model replicas;
determining a number of stages that divide the one or more repeating blocks, wherein devices partitioned into each model replica are partitioned into the number of stages;
determining a number of cell replicas for each cell in a block, wherein each cell replica represents a copy of the corresponding cell, wherein devices partitioned into each stage are partitioned into the number of cell replicas; and
for each cell replica of a cell, generating a task mapping which maps the set of tasks included in the cell to devices partitioned into the cell replica.

12. The computing system of claim 11, wherein the number of model replicas is a divisor of a count of repeating blocks, wherein devices included in the device cluster are evenly partitioned into the number of model replicas.

13. The computing system of claim 11, wherein the number of stages is a divisor of a count of devices partitioned into each model replica, wherein devices partitioned into each model replica are evenly partitioned into the number of stages.

14. The computing system of claim 11, wherein the number of cell replicas is a divisor of a count of devices partitioned into each stage, wherein devices partitioned into each stage are evenly partitioned into the number of cell replicas.

15. The computing system of claim 11, wherein the generating the task mapping comprises dividing the set of tasks included in the cell evenly or substantially evenly among devices partitioned into the cell replica.

16. The computing system of claim 15, wherein the generating the task mapping further comprises determining a type of collective communications specific to the cell to combine outputs of the set of tasks that are divided among devices partitioned into the cell replica.

17. The computing system of claim 11, wherein each block has two adjacent cells that have different numbers of cell replicas, the method further comprising determining resharding operations between the two adjacent cells.

18. The computing system of claim 11, further comprising selecting, among the plurality of parallel schedules, an optimal parallel schedule whose estimated processing time is the lowest for executing the transformer model on the device cluster to process a workload.

19. The computing system of claim 18, wherein the selecting comprises simulating execution of the transformer model on the device cluster to process the workload using each one of the plurality of parallel schedules.

20. One or more computer-readable media having encoded thereon computer-executable instructions causing one or more processors to perform a method, the method comprising:
receiving an internal representation of a transformer model, wherein the internal representation defines one or more repeating blocks, each block comprising a sequence of cells, and each cell comprising a set of tasks of the transformer model; and
searching for a plurality of parallel schedules for partitioning devices included in a device cluster for parallel execution of the transformer model, wherein the searching comprises:
determining a number of model replicas, wherein each model replica represents a copy of the transformer model, wherein devices included in the device cluster are partitioned into the number of model replicas;
determining a number of stages that divide the one or more repeating blocks, wherein devices partitioned into each model replica are partitioned into the number of stages;
determining a number of cell replicas for each cell in a block, wherein each cell replica represents a copy of the corresponding cell, wherein devices partitioned into each stage are partitioned into the number of cell replicas; and
for each cell replica of a cell, generating a task mapping which maps the set of tasks included in the cell to devices partitioned into the cell replica.
